(19) United States
(12) Patent Application Publication
(10) Pub. No.: US 2024/0402664 A1
(43) Pub. Date: Dec. 5, 2024

(54) BUILDING MANAGEMENT SYSTEM WITH BUILDING EQUIPMENT SERVICING

(71) Applicant: Tyco Fire & Security GmbH, Neuhausen am Rheinfall (CH)

(72) Inventors: Prashanthi Sudhakar, San Francisco, CA (US); Vineet Binodshanker Sinha, Brookfield, WI (US); Gregory A. Makowski, Los Altos, CA (US); Julie Joanne Brown, Yardley, PA (US)

(21) Appl. No.: 18/679,201

(22) Filed: May 30, 2024

Related U.S. Application Data
(60) Provisional application No. 63/470,156, filed on May 31, 2023.

(51) Int. Cl. G05B 15/02; G05B 13/02

(52) U.S. Cl. CPC G05B 15/02; G05B 13/029

(57) ABSTRACT

Systems and methods are disclosed relating to democratizing entity data utilizing machine learning models and/or generative AI. A system can include one or more processors configured to receive a prompt identifying an item of equipment for service. The one or more processors can generate, using at least one machine learning model and based on the prompt, a completion representing a service action to perform for the item of equipment, the at least one machine learning model configured using training data including a plurality of unstructured data elements corresponding to items of equipment. The one or more processors can present the completion using at least one of a display device or an audio output device.

### CROSS-REFERENCE TO RELATED APPLICATIONS

This application claims the benefit of and priority to U.S. Provisional Application No. 63/470,156, filed May 31, 2023, the disclosure of which is incorporated herein by reference in its entirety.

### BACKGROUND

This application relates generally to a building system of a building. This application relates more particularly to systems for managing and processing data of the building system. Various interactions between building systems, components of building systems, users, technicians, and/or devices managed by users or technicians can rely on timely generation and presentation of data relating to the interactions, including for performing service operations. However, it can be difficult to generate the data elements to precisely identify proper response actions or sequences of response actions, as well as options for modified response actions, depending on various factors.

### SUMMARY

Some implementations relate to a method, including receiving, by one or more processors, a prompt identifying an item of equipment for service. The method further including generating, by the one or more processors using at least one generative artificial intelligence (AI) model and based on the prompt, a completion representing a service action to perform for the item of equipment, the at least one generative AI model configured using training data including a plurality of unstructured data elements corresponding to items of equipment. The method further including presenting, by the one or more processors, the completion using at least one of a display device or an audio output device.

In some implementations, the plurality of unstructured data elements corresponding to the items of equipment include at least one of service reports, maintenance records, manufacturer instructions, images of the item of equipment, audio recordings of equipment operating sounds, expert technician records, or media including identification tags or labels of the items of equipment. In some implementations, the method further including comparing, by the one or more processors using a plurality of modalities of data input, the completion representing the service action to: a first modality of the plurality of modalities corresponding to historical service actions associated with similar items of equipment in the plurality of unstructured data elements, and a second modality of the plurality of modalities corresponding to operational data from one or more sensors attached to the item of equipment and refining or updating, by the one or more processors, the completion based on the comparison.

In some implementations, in response to receiving the prompt identifying the item of equipment for service accessing or identifying, by the one or more processors, the operational data of the one or more sensors attached to the item of equipment, activating, by the one or more processors, co-pilot model of the at least one generative AI model by initiating a session to assist in servicing the item of equipment based on the plurality of unstructured data elements and the operational data of the item of equipment, and generating the completion representing the service action is based on receiving the prompt and the operational data being provided as input into the at least one generative AI model. In some implementations, the method further including identifying, by the one or more processors, the operational data at a plurality of points in time correspond with the service action, the operational data correspond to measured parameters including at least one of temperature measurements, indoor air quality measurements, pressure measurements, vibration measurements, decibel measurements, flow rate measurements, energy consumption measurements, electrical current measurements.

In some implementations, the method further including determining, by the one or more processors, the item of equipment includes at least one connectivity element based on including at least one factory-installed communication system or retrofit communication system for facilitating data transmission, facilitating, by the one or more processors, a secure connection with the item of equipment based on transmitting a connection request to the at least one connectivity element and receiving a confirmation response including a session key and acknowledgement of the secure connection, and monitoring, by the one or more processors using the secure connection, the item of equipment in response to presenting the completion by accessing or receiving diagnosis information, real-time state data of the item of equipment, or the operational data. In some implementations, the method further including assigning, by the one or more processors, weights to the plurality of unstructured data elements in the training data, the weights are determined based on one or more of a type of a data source, a granularity of the plurality of unstructured data elements, a relatedness of the plurality of unstructured data elements to the item of equipment, or an experience level of a human source contributing the plurality of unstructured data elements.

In some implementations, the method further including re-evaluating and adjusting, by the one or more processors, the assigned weights to the plurality of unstructured data elements based on responses received from an effectiveness of previous service actions, changes in the experience level of the human source, or updates to the item of equipment. In some implementations, the generation of the completion representing the service action is further based on equipment-specific information including an age of the item of equipment and a service history including previous service actions performed on the item of equipment and the at least one generative AI model identifies one or more patterns in the service history of the item of equipment, correlates the one or more patterns with the age and the service history of the item of equipment, to generate the completion representing the service action.

In some implementations, the method further including identifying, by the one or more processors, a potential service action associated with a preventive maintenance action based on the age and the service history of the item of equipment, the completion representing the service action further includes the preventive maintenance action, the completion representing the service action includes a suggested timeline for future service actions based on an urgency of the future service action and an operational requirement of the item of equipment and scheduling, by the one or more processors, the future service actions based on the equipment-specific information, an estimated completion, and an availability of a service professional. In some implementations, the at least one generative AI model utilizes natural language processing (NLP) to interpret the plurality of unstructured data elements and the at least one generative AI model implements reinforcement learning, the reinforcement learning includes updating the at least one generative AI model based on receiving feedback on an effectiveness of generated completions representing service actions.

Some implementations relate to a method, including receiving, by one or more processors, a prompt identifying an item of equipment for service. The method further including generating, by the one or more processors using at least one machine learning model and based on the prompt, a completion representing a service action to perform for the item of equipment, the at least one machine learning model configured using training data including a plurality of unstructured data elements corresponding to items of equipment. The method further including presenting, by the one or more processors, the completion using at least one of a display device or an audio output device.

In some implementations, the method further including comparing, by the one or more processors using a plurality of modalities of data input, the completion representing the service action to: a first modality of the plurality of modalities corresponding to historical service actions associated with similar items of equipment in the plurality of unstructured data elements, and a second modality of the plurality of modalities corresponding to operational data from one or more sensors attached to the item of equipment and refining or updating, by the one or more processors, the completion based on the comparison. In some implementations, in response to receiving the prompt identifying the item of equipment for service accessing or identifying, by the one or more processors, the operational data of the one or more sensors attached to the item of equipment, activating, by the one or more processors, co-pilot model of the at least one machine learning model by initiating a session to assist in servicing the item of equipment based on the plurality of unstructured data elements and the operational data of the item of equipment, and generating the completion representing the service action is based on receiving the prompt and the operational data being provided as input into the at least one generative AI model. In some implementations, the at least one machine learning model utilizes natural language processing (NLP) to interpret the plurality of unstructured data elements and the at least one machine learning model implements reinforcement learning, the reinforcement learning includes updating the at least one machine learning model based on receiving feedback on an effectiveness of generated completions representing service actions.

Some implementations relate to a system, including processing circuits including memory and at least one processor. The at least one processor is configured to receive a prompt identifying an item of equipment for service. The at least one processor is further configured to generate, using at least one generative artificial intelligence (AI) model and based on the prompt, a completion representing a service action to perform for the item of equipment, the at least one generative AI model configured using training data including a plurality of unstructured data elements corresponding to items of equipment. The at least one processor is configured to present the completion using at least one of a display device or an audio output device.

In some implementations, the plurality of unstructured data elements corresponding to the items of equipment include at least one of service reports, maintenance records, manufacturer instructions, images of the item of equipment, audio recordings of equipment operating sounds, expert technician records, or media including identification tags or labels of the items of equipment. In some implementations, the at least one processor is further configured to compare, using a plurality of modalities of data input, the completion representing the service action to: a first modality of the plurality of modalities corresponding to historical service actions associated with similar items of equipment in the plurality of unstructured data elements, and a second modality of the plurality of modalities corresponding to operational data from one or more sensors attached to the item of equipment and refine or update the completion based on the comparison.

In some implementations, in response to receiving the prompt identifying the item of equipment for service, the at least one processor is further configured to accessing or identifying, by the one or more processors, the operational data of the one or more sensors attached to the item of equipment activate co-pilot model of the at least one generative AI model by initiating a session to assist in servicing the item of equipment based on the plurality of unstructured data elements and the operational data of the item of equipment, and generating the completion representing the service action is based on receiving the prompt and the operational data being provided as input into the at least one generative AI model. In some implementations, the at least one processor is further configured to determine the item of equipment includes at least one connectivity element based on including at least one factory-installed communication system or retrofit communication system for facilitating data transmission, facilitate a secure connection with the item of equipment based on transmitting a connection request to the at least one connectivity element and receiving a confirmation response including a session key and acknowledgement of the secure connection, and monitor, using the secure connection, the item of equipment in response to presenting the completion by accessing or receiving diagnosis information, real-time state data of the item of equipment, or the operational data.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a block diagram of an example of a machine learning model-based system for equipment servicing applications.

FIG. 2 is a block diagram of an example of a language model-based system for equipment servicing applications.

FIG. 3 is a block diagram of an example of the system of FIG. 2 including user application session components.

FIG. 4 is a block diagram of an example of the system of FIG. 2 including feedback training components.

FIG. 5 is a block diagram of an example of the system of FIG. 2 including data filters.

FIG. 6 is a block diagram of an example of the system of FIG. 2 including data validation components.

FIG. 7 is a block diagram of an example of the system of FIG. 2 including expert review and intervention components.

FIG. 8 is a flow diagram of a method of managing equipment servicing responsive to fault detection using machine learning models.

FIG. 9 is a flow diagram of a method of using machine learning models to generate content regarding items of equipment.

FIGS. 10A-10B are example graphical interfaces for facilitating and generating example communications with a technician.

### DETAILED DESCRIPTION

Referring generally to the FIGURES, systems and methods in accordance with the present disclosure can implement various systems to precisely generate data relating to operations to be performed for managing building systems and components and/or items of equipment, including heating, ventilation, cooling, and/or refrigeration (HVAC-R) systems and components. For example, various systems described herein can implement generating data for numerous applications, including virtual assistance for technicians handling service requests, generating service-related technical reports, facilitating diagnostics and troubleshooting procedures, and providing recommendations for services or products to be utilized during service operations. These applications can assist in both asynchronous and real-time service operations by generating text data, using data from diverse data sources that may not have predefined database associations, yet may be pertinent at certain steps or moments during service operations.

In some systems, service operations can be supported by text information, such as predefined text documents such as service, diagnostic, and/or troubleshooting guides. Various such text information may not be useful for specific service requests and/or technicians performing the service. For example, the text information may correspond to different items of equipment or versions of items of equipment to be serviced. The text information, being predefined, may not account for specific technical issues that may be present in the items of equipment to be serviced.

AI and/or machine learning (ML) systems, including but not limited to LLMs, can be used to receive prompts that identify a piece of equipment for service. These prompts, which could originate from a variety of user interfaces can request data concerning the operation, management, or status of one or more items of equipment. Importantly, the generative AI model, powered by the processing circuits, interprets these equipment-focused prompts to generate tailored and actionable guidance. In this way, the system democratizes expert knowledge, transforming it into practical steps that can be carried out by less experienced users to improve the performance of the identified equipment. This happens by the generative AI model accessing unstructured data (e.g., representing expert knowledge) and converting it into step-by-step, user-friendly guidance for technicians with varying degrees of experience.

Moreover, the AI and ML systems can suggest appropriate actions to address particular issues associated with the identified equipment. These actions could include, for instance, suggesting adjustments to HVAC settings or recommending preventative maintenance for certain equipment. By translating expert knowledge into user-friendly insights, the system empowers novice users to effectively manage the identified equipment.

As outlined in the FIGURES, these systems and methods employ a generative AI model to manage building systems and equipment that improves efficiency and effectiveness. By interpreting equipment-specific prompts, the system can provide personalized responses tailored to the unique needs of each piece of equipment. This approach democratizes access to expert knowledge, moving beyond the limitations of static, predefined service guides. In particular, the system employs the power of unstructured data, which often contains invaluable expert knowledge, and repurposes it into usable advice for less experienced users. This technical solution democratizes building system management by providing real-time, personalized assistance and recommendations, improving service, building operations, and the performance evaluation of the whole system.

Furthermore, AI and/or machine learning (ML) systems, including but not limited to LLMs, can be used to generate text data and data of other modalities in a more responsive manner to real-time conditions, including generating strings of text data that may not be provided in the same manner in existing documents, yet may still meet criteria for useful text information, such as relevance, style, and coherence. For example, LLMs can predict text data based at least on inputted prompts and by being configured (e.g., trained, modified, updated, fine-tuned) according to training data representative of the text data to predict or otherwise generate.

However, various considerations may limit the ability of such systems to precisely generate appropriate data for specific conditions. For example, due to the predictive nature of the generated data, some LLMs may generate text data that is incorrect, imprecise, or not relevant to the specific conditions. Using the LLMs may require a user to manually vary the content and/or syntax of inputs provided to the LLMs (e.g., vary inputted prompts) until the output of the LLMs meets various objective or subjective criteria of the user. The LLMs can have token limits for sizes of inputted text during training and/or runtime/inference operations (and relaxing or increasing such limits may require increased computational processing, API calls to LLM services, and/or memory usage), limiting the ability of the LLMs to be effectively configured or operated using large amounts of raw data or otherwise unstructured data.

Systems and methods in accordance with the present disclosure can use machine learning models, including LLMs and other generative AI systems, to capture data, including but not limited to unstructured knowledge from various data sources, and process the data to accurately generate outputs, such as completions responsive to prompts, including in structured data formats for various applications and use cases. The system can implement various automated and/or expert-based thresholds and data quality management processes to improve the accuracy and quality of generated outputs and update training of the machine learning models accordingly. The system can provide real-time messaging and/or conversational interfaces for users to provide field data regarding equipment to the system (including presenting targeted queries to users that are expected to elicit relevant responses for efficiently receiving useful response information from users) and guide users, such as service technicians, through relevant service, diagnostic, troubleshooting, and/or repair processes.

This can include, for example, receiving data from technician service reports in various formats, including various modalities and/or multi-modal formats (e.g., text, speech, audio, image, and/or video). The system can facilitate automated, flexible customer report generation, such as by processing information received from service technicians and other users into a standardized format, which can reduce the constraints on how the user submits data while improving resulting reports. The system can couple unstructured service data to other input/output data sources and analytics, such as to relate unstructured data with outputs of timeseries data from equipment (e.g., sensor data; report logs) and/or outputs from models or algorithms of equipment operation, which can facilitate more accurate analytics, prediction services, diagnostics, and/or fault detection. The system can perform classification or other pattern recognition or trend detection operations to facilitate more timely assignment of technicians, scheduling of technicians based on expected times for jobs, and provisioning of trucks, tools, and/or parts. The system can perform root cause prediction by being trained using data that includes indications of root causes of faults or errors, where the indications are labels for or otherwise associated with (unstructured or structure) data such as service requests, service reports, service calls, etc. The system can receive, from a service technician in the field evaluating the issue with the equipment, feedback regarding the accuracy of the root cause predictions, as well as feedback regarding how the service technician evaluated information about the equipment (e.g., what data did they evaluate; what did they inspect; did the root cause prediction or instructions for finding the root cause accurately match the type of equipment, etc.), which can be used to update the root cause prediction model.

For example, the system can provide a platform for fault detection and servicing processes in which a machine learning model is configured based on connecting or relating unstructured data and/or semantic data, such as human feedback and written/spoken reports, with time-series product data regarding items of equipment, so that the machine learning model can more accurately detect causes of alarms or other events that may trigger service responses. For instance, responsive to an alarm for a chiller, the system can more accurately detect a cause of the alarm, and generate a prescription (e.g., for a service technician) for responding to the alarm; the system can request feedback from the service technician regarding the prescription, such as whether the prescription correctly identified the cause of the alarm and/or actions to perform to respond to the cause, as well as the information that the service technician used to evaluate the correctness or accuracy of the prescription; the system can use this feedback to modify the machine learning models, which can increase the accuracy of the machine learning models.

In some instances, significant computational resources (or human user resources) can be required to process data relating to equipment operation, such as time-series product data and/or sensor data, to detect or predict faults and/or causes of faults. In addition, it can be resource-intensive to label such data with identifiers of faults or causes of faults, which can make it difficult to generate machine learning training data from such data. Systems and methods in accordance with the present disclosure can leverage the efficiency of language models (e.g., GPT-based models or other pre-trained LLMs) in extracting semantic information (e.g., semantic information identifying faults, causes of faults, and other accurate expert knowledge regarding equipment servicing) from the unstructured data in order to use both the unstructured data and the data relating to equipment operation to generate more accurate outputs regarding equipment servicing. As such, by implementing language models using various operations and processes described herein, building management and equipment servicing systems can take advantage of the causal/semantic associations between the unstructured data and the data relating to equipment operation, and the language models can allow these systems to more efficiently extract these relationships in order to more accurately predict targeted, useful information for servicing applications at inference-time/runtime. While various implementations are described as being implemented using generative AI models such as transformers and/or GANs, in some embodiments, various features described herein can be implemented using non-generative AI models or even without using AI/machine learning, and all such modifications fall within the scope of the present disclosure.

The system can provide a generative AI-based service wizard interface. For example, the interface can include user interface and/or user experience features configured to provide a question/answer-based input/output format, such as a conversational interface, that directs users through providing targeted information for accurately generating predictions of root cause, presenting solutions, or presenting instructions for repairing or inspecting the equipment to identify information that the system can use to detect root causes or other issues. The system can use the interface to present information regarding parts and/or tools to service the equipment, as well as instructions for how to use the parts and/or tools to service the equipment.

In various implementations, the systems can include a plurality of machine learning models that may be configured using integrated or disparate data sources. This can facilitate more integrated user experiences or more specialized (and/or lower computational usage for) data processing and output generation. Outputs from one or more first systems, such as one or more first algorithms or machine learning models, can be provided at least as part of inputs to one or more second systems, such as one or more second algorithms or machine learning models. For example, a first language model can be configured to process unstructured inputs (e.g., text, speech, images, etc.) into a structure output format compatible for use by a second system, such as a root cause prediction algorithm or equipment configuration model.

The system can be used to automate interventions for equipment operation, servicing, fault detection and diagnostics (FDD), and alerting operations. For example, by being configured to perform operations such as root cause prediction, the system can monitor data regarding equipment to predict events associated with faults and trigger responses such as alerts, service scheduling, and initiating FDD or modifications to configuration of the equipment. The system can present to a technician or manager of the equipment a report regarding the intervention (e.g., action taken responsive to predicting a fault or root cause condition) and requesting feedback regarding the accuracy of the intervention, which can be used to update the machine learning models to more accurately generate interventions.

### I. Machine Learning Models for Building Management and Equipment Servicing

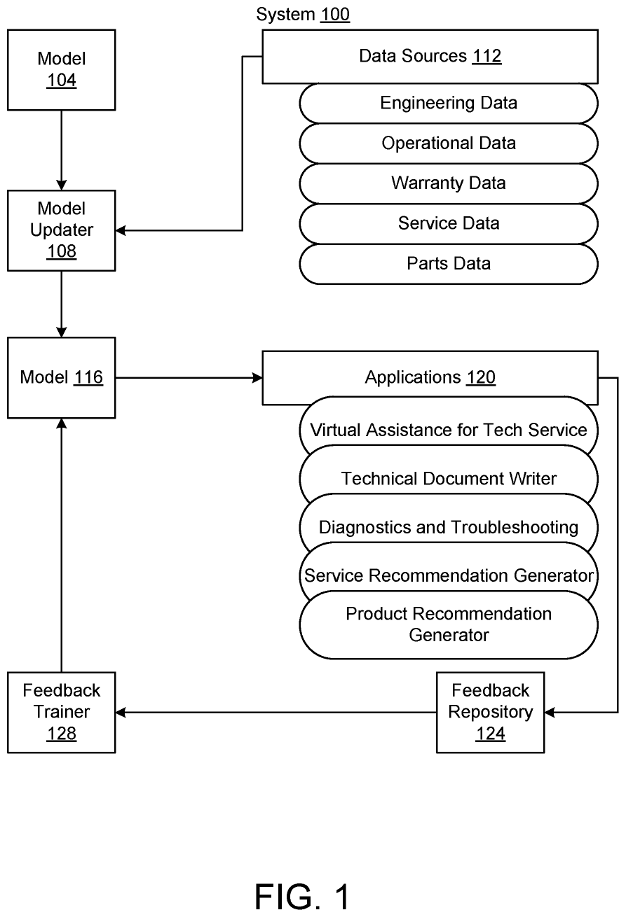

FIG. 1 depicts an example of a system 100. The system 100 can implement various operations for configuring (e.g., training, updating, modifying, transfer learning, fine-tuning, etc.) and/or operating various AI and/or ML systems, such as neural networks of LLMs or other generative AI systems. The system 100 can be used to implement various generative AI-based building equipment servicing operations.

For example, the system 100 can be implemented for operations associated with any of a variety of building management systems (BMSs) or equipment or components thereof. A BMS can include a system of devices that can control, monitor, and manage equipment in or around a building or building area. The BMS can include, for example, a HVAC system, a security system, a lighting system, a fire alerting system, any other system that is capable of managing building functions or devices, or any combination thereof. The BMS can include or be coupled with items of equipment, for example and without limitation, such as heaters, chillers, boilers, air handling units, sensors, actuators, refrigeration systems, fans, blowers, heat exchangers, energy storage devices, condensers, valves, or various combinations thereof.

The items of equipment can operate in accordance with various qualitative and quantitative parameters, variables, setpoints, and/or thresholds or other criteria, for example. In some instances, the system 100 and/or the items of equipment can include or be coupled with one or more controllers for controlling parameters of the items of equipment, such as to receive control commands for controlling operation of the items of equipment via one or more wired, wireless, and/or user interfaces of controller.

Various components of the system 100 or portions thereof can be implemented by one or more processors coupled with or more memory devices (memory). The processors can be a general purpose or specific purpose processors, an application specific integrated circuit (ASIC), one or more field programmable gate arrays (FPGAs), a group of processing components, or other suitable processing components. The processors may be configured to execute computer code and/or instructions stored in the memories or received from other computer readable media (e.g., CDROM, network storage, a remote server, etc.). The processors can be configured in various computer architectures, such as graphics processing units (GPUs), distributed computing architectures, cloud server architectures, client-server architectures, or various combinations thereof. One or more first processors can be implemented by a first device, such as an edge device, and one or more second processors can be implemented by a second device, such as a server or other device that is communicatively coupled with the first device and may have greater processor and/or memory resources.

The memories can include one or more devices (e.g., memory units, memory devices, storage devices, etc.) for storing data and/or computer code for completing and/or facilitating the various processes described in the present disclosure. The memories can include random access memory (RAM), read-only memory (ROM), hard drive storage, temporary storage, non-volatile memory, flash memory, optical memory, or any other suitable memory for storing software objects and/or computer instructions. The memories can include database components, object code components, script components, or any other type of information structure for supporting the various activities and information structures described in the present disclosure. The memories can be communicably connected to the processors and can include computer code for executing (e.g., by the processors) one or more processes described herein.

### Machine Learning Models

The system 100 can include or be coupled with one or more first models 104. The first model 104 can include one or more neural networks, including neural networks configured as generative models. For example, the first model 104 can predict or generate new data (e.g., artificial data; synthetic data; data not explicitly represented in data used for configuring the first model 104). The first model 104 can generate any of a variety of modalities of data, such as text, speech, audio, images, and/or video data. The neural network can include a plurality of nodes, which may be arranged in layers for providing outputs of one or more nodes of one layer as inputs to one or more nodes of another layer. The neural network can include one or more input layers, one or more hidden layers, and one or more output layers. Each node can include or be associated with parameters such as weights, biases, and/or thresholds, representing how the node can perform computations to process inputs to generate outputs. The parameters of the nodes can be configured by various learning or training operations, such as unsupervised learning, weakly supervised learning, semi-supervised learning, or supervised learning.

The first model 104 can include, for example and without limitation, one or more language models, LLMs, attention-based neural networks, transformer-based neural networks, generative pretrained transformer (GPT) models, bidirectional encoder representations from transformers (BERT) models, encoder/decoder models, sequence to sequence models, autoencoder models, generative adversarial networks (GANs), convolutional neural networks (CNNs), recurrent neural networks (RNNs), diffusion models (e.g., denoising diffusion probabilistic models (DDPMs)), or various combinations thereof.

For example, the first model 104 can include at least one GPT model. The GPT model can receive an input sequence, and can parse the input sequence to determine a sequence of tokens (e.g., words or other semantic units of the input sequence, such as by using Byte Pair Encoding tokenization). The GPT model can include or be coupled with a vocabulary of tokens, which can be represented as a one-hot encoding vector, where each token of the vocabulary has a corresponding index in the encoding vector; as such, the GPT model can convert the input sequence into a modified input sequence, such as by applying an embedding matrix to the token tokens of the input sequence (e.g., using a neural network embedding function), and/or applying positional encoding (e.g., sin-cosine positional encoding) to the tokens of the input sequence. The GPT model can process the modified input sequence to determine a next token in the sequence (e.g., to append to the end of the sequence), such as by determining probability scores indicating the likelihood of one or more candidate tokens being the next token, and selecting the next token according to the probability scores (e.g., selecting the candidate token having the highest probability scores as the next token). For example, the GPT model can apply various attention and/or transformer based operations or networks to the modified input sequence to identify relationships between tokens for detecting the next token to form the output sequence.

The first model 104 can include at least one diffusion model, which can be used to generate image and/or video data. For example, the diffusional model can include a denoising neural network and/or a denoising diffusion probabilistic model neural network. The denoising neural network can be configured by applying noise to one or more training data elements (e.g., images, video frames) to generate noised data, providing the noised data as input to a candidate denoising neural network, causing the candidate denoising neural network to modify the noised data according to a denoising schedule, evaluating a convergence condition based on comparing the modified noised data with the training data instances, and modifying the candidate denoising neural network according to the convergence condition (e.g., modifying weights and/or biases of one or more layers of the neural network). In some implementations, the first model 104 includes a plurality of generative models, such as GPT and diffusion models, that can be trained separately or jointly to facilitate generating multi-modal outputs, such as technical documents (e.g., service guides) that include both text and image/video information.

In some implementations, the first model 104 can be configured using various unsupervised and/or supervised training operations. The first model 104 can be configured using training data from various domain-agnostic and/or domain-specific data sources, including but not limited to various forms of text, speech, audio, image, and/or video data, or various combinations thereof. The training data can include a plurality of training data elements (e.g., training data instances). Each training data element can be arranged in structured or unstructured formats; for example, the training data element can include an example output mapped to an example input, such as a query representing a service request or one or more portions of a service request, and a response representing data provided responsive to the query. The training data can include data that is not separated into input and output subsets (e.g., for configuring the first model 104 to perform clustering, classification, or other unsupervised ML operations). The training data can include human-labeled information, including but not limited to feedback regarding outputs of the models 104, 116. This can allow the system 100 to generate more human-like outputs.

In some implementations, the training data includes data relating to building management systems. For example, the training data can include examples of HVAC-R data, such as operating manuals, technical data sheets, configuration settings, operating setpoints, diagnostic guides, troubleshooting guides, user reports, technician reports. In some implementations, the training data used to configure the first model 104 includes at least some publicly accessible data, such as data retrievable via the Internet.

Referring further to FIG. 1, the system 100 can configure the first model 104 to determine one or more second models 116. For example, the system 100 can include a model updater 108 that configures (e.g., trains, updates, modifies, fine-tunes, etc.) the first model 104 to determine the one or more second models 116. In some implementations, the second model 116 can be used to provide application-specific outputs, such as outputs having greater precision, accuracy, or other metrics, relative to the first model, for targeted applications.

The second model 116 can be similar to the first model 104. For example, the second model 116 can have a similar or identical backbone or neural network architecture as the first model 104. In some implementations, the first model 104 and the second model 116 each include generative AI machine learning models, such as LLMs (e.g., GPT-based LLMs) and/or diffusion models. The second model 116 can be configured using processes analogous to those described for configuring the first model 104.

In some implementations, the model updater 108 can perform operations on at least one of the first model 104 or the second model 116 via one or more interfaces, such as application programming interfaces (APIs). For example, the models 104, 116 can be operated and maintained by one or more systems separate from the system 100. The model updater 108 can provide training data to the first model 104, via the API, to determine the second model 116 based on the first model 104 and the training data. The model updater 108 can control various training parameters or hyperparameters (e.g., learning rates, etc.) by providing instructions via the API to manage configuring the second model 116 using the first model 104.

### Data Sources

The model updater 108 can determine the second model 116 using data from one or more data sources 112. For example, the system 100 can determine the second model 116 by modifying the first model 104 using data from the one or more data sources 112. The data sources 112 can include or be coupled with any of a variety of integrated or disparate databases, data warehouses, digital twin data structures (e.g., digital twins of items of equipment or building management systems or portions thereof), data lakes, data repositories, documentation records, or various combinations thereof. In some implementations, the data sources 112 include HVAC-R data in any of text, speech, audio, image, or video data, or various combinations thereof, such as data associated with HVAC-R components and procedures including but not limited to installation, operation, configuration, repair, servicing, diagnostics, and/or troubleshooting of HVAC-R components and systems. Various data described below with reference to data sources 112 may be provided in the same or different data elements, and may be updated at various points. The data sources 112 can include or be coupled with items of equipment (e.g., where the items of equipment output data for the data sources 112, such as sensor data, etc.). The data sources 112 can include various online and/or social media sources, such as blog posts or data submitted to applications maintained by entities that manage the buildings. The system 100 can determine relations between data from different sources, such as by using timeseries information and identifiers of the sites or buildings at which items of equipment are present to detect relationships between various different data relating to the items of equipment (e.g., to train the models 104, 116 using both timeseries data (e.g., sensor data; outputs of algorithms or models, etc.) regarding a given item of equipment and freeform natural language reports regarding the given item of equipment).

The data sources 112 can include unstructured data or structured data (e.g., data that is labeled with or assigned to one or more predetermined fields or identifiers). For example, using the first model 104 and/or second model 116 to process the data can allow the system 100 to extract useful information from data in a variety of formats, including unstructured/freeform formats, which can allow service technicians to input information in less burdensome formats. The data can be of any of a plurality of formats (e.g., text, speech, audio, image, video, etc.), including multi-modal formats. For example, the data may be received from service technicians in forms such as text (e.g., laptop/desktop or mobile application text entry), audio, and/or video (e.g., dictating findings while capturing video).

The data sources 112 can include engineering data regarding one or more items of equipment. The engineering data can include manuals, such as installation manuals, instruction manuals, or operating procedure guides. The engineering data can include specifications or other information regarding operation of items of equipment. The engineering data can include engineering drawings, process flow diagrams, refrigeration cycle parameters (e.g., temperatures, pressures), or various other information relating to structures and functions of items of equipment.

In some implementations, the data sources 112 can include operational data regarding one or more items of equipment. The operational data can represent detected information regarding items of equipment, such as sensor data, logged data, user reports, or technician reports. The operational data can include, for example, service tickets generated responsive to requests for service, work orders, data from digital twin data structures maintained by an entity of the item of equipment, outputs or other information from equipment operation models (e.g., chiller vibration models), or various combinations thereof. Logged data, user reports, service tickets, billing records, time sheets, and various other such data can provide temporal information, such as how long service operations may take, or durations of time between service operations, which can allow the system 100 to predict resources to use for performing service as well as when to request service.

The data sources 112 can include, for instance, warranty data. The warranty data can include warranty documents or agreements that indicate conditions under which various entities associated with items of equipment are to provide service, repair, or other actions corresponding to items of equipment, such as actions corresponding to service requests.

The data sources 112 can include service data. The service data can include data from any of various service providers, such as service reports. The service data can indicate service procedures performed, including associated service procedures with initial service requests and/or sensor data related conditions to trigger service and/or sensor data measured during service processes.

In some implementations, the data sources 112 can include parts data, including but not limited to parts usage and sales data. For example, the data sources 112 can indicate various parts associated with installation or repair of items of equipment. The data sources 112 can indicate tools for performing service and/or installing parts.

The system 100 can include, with the data of the data sources 112, labels to facilitate cross-reference between items of data that may relate to common items of equipment, sites, service technicians, customers, or various combinations thereof. For example, data from disparate sources may be labeled with time data, which can allow the system 100 (e.g., by configuring the models 104, 116) to increase a likelihood of associating information from the disparate sources due to the information being detected or recorded (e.g., as service reports) at the same time or near in time.

For example, the data sources 112 can include data that can be particular to specific or similar items of equipment, buildings, equipment configurations, environmental states, or various combinations thereof. In some implementations, the data includes labels or identifiers of such information, such as to indicate locations, weather conditions, timing information, uses of the items of equipment or the buildings or sites at which the items of equipment are present, etc. This can facilitate the models 104, 116 to detect patterns of usage (e.g., spikes; troughs; seasonal or other temporal patterns) or other information that may be useful for determining causes of issues or causes of service requests, or predict future issues, such as to allow the models 104, 116 to be trained using information indicative of causes of issues across multiple items of equipment (which may have the same or similar causes even if the data regarding the items of equipment is not identical). For example, an item of equipment may be at a site that is a museum; by relating site usage or occupancy data with data regarding the item of equipment, such as sensor data and service reports, the system 100 can configure the models 104, 116 to determine a high likelihood of issues occurring before events associated with high usage (e.g., gala, major exhibit opening), and can generate recommendations to perform diagnostics or servicing prior to the events.

### Model Configuration

Referring further to FIG. 1, the model updater 108 can perform various machine learning model configuration/training operations to determine the second models 116 using the data from the data sources 112. For example, the model updater 108 can perform various updating, optimization, retraining, reconfiguration, fine-tuning, or transfer learning operations, or various combinations thereof, to determine the second models 116. The model updater 108 can configure the second models 116, using the data sources 112, to generate outputs (e.g., completions) in response to receiving inputs (e.g., prompts), where the inputs and outputs can be analogous to data of the data sources 112.

For example, the model updater 108 can identify one or more parameters (e.g., weights and/or biases) of one or more layers of the first model 104, and maintain (e.g., freeze, maintain as the identified values while updating) the values of the one or more parameters of the one or more layers. In some implementations, the model updater 108 can modify the one or more layers, such as to add, remove, or change an output layer of the one or more layers, or to not maintain the values of the one or more parameters. The model updater 108 can select at least a subset of the identified one or parameters to maintain according to various criteria, such as user input or other instructions indicative of an extent to which the first model 104 is to be modified to determine the second model 116. In some implementations, the model updater 108 can modify the first model 104 so that an output layer of the first model 104 corresponds to output to be determined for applications 120.

Responsive to selecting the one or more parameters to maintain, the model updater 108 can apply, as input to the second model 116 (e.g., to a candidate second model 116, such as the modified first model 104, such as the first model 104 having the identified parameters maintained as the identified values), training data from the data sources 112. For example, the model updater 108 can apply the training data as input to the second model 116 to cause the second model 116 to generate one or more candidate outputs.

The model updater 108 can evaluate a convergence condition to modify the candidate second model 116 based at least on the one or more candidate outputs and the training data applied as input to the candidate second model 116. For example, the model updater 108 can evaluate an objective function of the convergence condition, such as a loss function (e.g., L1 loss, L2 loss, root mean square error, cross-entropy or log loss, etc.) based on the one or more candidate outputs and the training data; this evaluation can indicate how closely the candidate outputs generated by the candidate second model 116 correspond to the ground truth represented by the training data. The model updater 108 can use any of a variety of optimization algorithms (e.g., gradient descent, stochastic descent, Adam optimization, etc.) to modify one or more parameters (e.g., weights or biases of the layer(s) of the candidate second model 116 that are not frozen) of the candidate second model 116 according to the evaluation of the objective function. In some implementations, the model updater 108 can use various hyperparameters to evaluate the convergence condition and/or perform the configuration of the candidate second model 116 to determine the second model 116, including but not limited to hyperparameters such as learning rates, numbers of iterations or epochs of training, etc.

As described further herein with respect to applications 120, in some implementations, the model updater 108 can select the training data from the data of the data sources 112 to apply as the input based at least on a particular application of the plurality of applications 120 for which the second model 116 is to be used for. For example, the model updater 108 can select data from the parts data source 112 for the product recommendation generator application 120, or select various combinations of data from the data sources 112 (e.g., engineering data, operational data, and service data) for the service recommendation generator application 120. The model updater 108 can apply various combinations of data from various data sources 112 to facilitate configuring the second model 116 for one or more applications 120.

In some implementations, the system 100 can perform at least one of conditioning, classifier-based guidance, or classifier-free guidance to configure the second model 116 using the data from the data sources 112. For example, the system 100 can use classifiers associated with the data, such as identifiers of the item of equipment, a type of the item of equipment, a type of entity operating the item of equipment, a site at which the item of equipment is provided, or a history of issues at the site, to condition the training of the second model 116. For example, the system 100 combine (e.g., concatenate) various such classifiers with the data for inputting to the second model 116 during training, for at least a subset of the data used to configure the second model 116, which can facilitate the second model 116 to be responsive to analogous information for runtime/inference time operations.

### Applications

Referring further to FIG. 1, the system 100 can use outputs of the one or more second models 116 to implement one or more applications 120. For example, the second models 116, having been configured using data from the data sources 112, can be capable of precisely generating outputs that represent useful, timely, and/or real-time information for the applications 120. In some implementations, each application 120 is coupled with a corresponding second model 116 that is configured to generate outputs for use by the application 120. Various applications 120 can be coupled with one another, such as to provide outputs from a first application 120 as inputs or portions of inputs to a second application 120.

The applications 120 can include any of a variety of desktop, web-based/browser-based, or mobile applications. For example, the applications 120 can be implemented by enterprise management software systems, employee or other user applications (e.g., applications that relate to BMS functionality such as temperature control, user preferences, conference room scheduling, etc.), equipment portals that provide data regarding items of equipment, or various combinations thereof. The applications 120 can include user interfaces, wizards, checklists, conversational interfaces, chatbots, configuration tools, or various combinations thereof. The applications 120 can receive an input, such as a prompt (e.g., from a user), provide the prompt to the second model 116 to cause the second model 116 to generate an output, such as a completion in response to the prompt, and present an indication of the output. The applications 120 can receive inputs and/or present outputs in any of a variety of presentation modalities, such as text, speech, audio, image, and/or video modalities. For example, the applications 120 can receive unstructured or freeform inputs from a user, such as a service technician, and generate reports in a standardized format, such as a customer-specific format. This can allow, for example, technicians to automatically, and flexibly, generate customer-ready reports after service visits without requiring strict input by the technician or manually sitting down and writing reports; to receive inputs as dictations in order to generate reports; to receive inputs in any form or a variety of forms, and use the second model 116 (which can be trained to cross-reference metadata in different portions of inputs and relate together data elements) to generate output reports (e.g., the second model 116, having been configured with data that includes time information, can use timestamps of input from dictation and timestamps of when an image is taken, and place the image in the report in a target position or label based on time correlation).

In some implementations, the applications 120 include at least one virtual assistant (e.g., virtual assistance for technician services) application 120. The virtual assistant application can provide various services to support technician operations, such as presenting information from service requests, receiving queries regarding actions to perform to service items of equipment, and presenting responses indicating actions to perform to service items of equipment. The virtual assistant application can receive information regarding an item of equipment to be serviced, such as sensor data, text descriptions, or camera images, and process the received information using the second model 116 to generate corresponding responses.

For example, the virtual assistant application 120 can be implemented in a UI/UX wizard configuration, such as to provide a sequence of requests for information from the user (the sequence may include requests that are at least one of predetermined or dynamically generated responsive to inputs from the user for previous requests). For example, the virtual assistant application 120 can provide one or more requests for users such as service technicians, facility managers, or other occupants, and provide the received responses to at least one of the second model 116 or a root cause detection function (e.g., algorithm, model, data structure mapping inputs to candidate causes, etc.) to determine a prediction of a cause of the issue of the item of equipment and/or solutions. The virtual assistant application 120 can use requests for information such as for unstructured text by which the user describes characteristics of the item of equipment relating to the issue; answers expected to correspond to different scenarios indicative of the issue; and/or image and/or video input (e.g., images of problems, equipment, spaces, etc. that can provide more context around the issue and/or configurations). For example, responsive to receiving a response via the virtual assistant application 120 indicating that the problem is with temperature in the space, the system 100 can request, via the virtual assistant application 120, information regarding HVAC-R equipment associated with the space, such as pictures of the space, an air handling unit, a chiller, or various combinations thereof.

The virtual assistant application 120 can include a plurality of applications 120 (e.g., variations of interfaces or customizations of interfaces) for a plurality of respective user types. For example, the virtual assistant application 120 can include a first application 120 for a customer user, and a second application 120 for a service technician user. The virtual assistant applications 120 can allow for updating and other communications between the first and second applications 120 as well as the second model 116. Using one or more of the first application 120 and the second application 120, the system 100 can manage continuous/real-time conversations for one or more users, and evaluate the users' engagement with the information provided (e.g., did the user, customer, service technician, etc., follow the provided steps for responding to the issue or performing service, did the user discontinue providing inputs to the virtual assistant application 120, etc.), such as to facilitate the system 100 to update the information generated by the second model 116 for the virtual assistant application 120 according to the engagement. In some implementations, the system 100 can use the second model 116 to detect sentiment of the user of the virtual assistant application 120, and update the second model 116 according to the detected sentiment, such as to improve the experience provided by the virtual assistant application 120.

The applications 120 can include at least one document writer application 120, such as a technical document writer. The document writer application 120 can facilitate preparing structured (e.g., form-based) and/or unstructured documentation, such as documentation associated with service requests. For example, the document writer application 120 can present a user interface corresponding to a template document to be prepared that is associated with at least one of a service request or the item of equipment for which the service request is generated, such as to present one or more predefined form sections or fields. The document writer application 120 can use inputs, such as prompts received from the users and/or technical data provided by the user regarding the item of equipment, such as sensor data, text descriptions, or camera images, to generate information to include in the documentation. For example, the document writer application 120 can provide the inputs to the second model 116 to cause the second model 116 to generate completions for text information to include in the fields of the documentation.

The applications 120 can include, in some implementations, at least one diagnostics and troubleshooting application 120. The diagnostics and troubleshooting application 120 can receive inputs including at least one of a service request or information regarding the item of equipment to be serviced, such as information identified by a service technician. The diagnostics and troubleshooting application 120 can provide the inputs to a corresponding second model 116 to cause the second model 116 to generate outputs such as indications of potential items to be checked regarding the item of equipment, modifications or fixes to make to perform the service, or values or ranges of values of parameters of the item of equipment that may be indicative of specific issues to for the service technician to address or repair.

The applications 120 can at least one service recommendation generator application 120. The service recommendation generator application 120 can receive inputs such as a service request or information regarding the item of equipment to be serviced, and provide the inputs to the second model 116 to cause the second model 116 to generate outputs for presenting service recommendations, such as actions to perform to address the service request.

In some implementations, the applications 120 can include a product recommendation generator application 120. The product recommendation generator application 120 can process inputs such as information regarding the item of equipment or the service request, using one or more second models 116 (e.g., models trained using parts data from the data sources 112), to determine a recommendation of a part or product to replace or otherwise use for repairing the item of equipment.

### Feedback Training

Referring further to FIG. 1, the system 100 can include at least one feedback trainer 128 coupled with at least one feedback repository 124. The system 100 can use the feedback trainer 128 to increase the precision and/or accuracy of the outputs generated by the second models 116 according to feedback provided by users of the system 100 and/or the applications 120.

The feedback repository 124 can include feedback received from users regarding output presented by the applications 120. For example, for at least a subset of outputs presented by the applications 120, the applications 120 can present one or more user input elements for receiving feedback regarding the outputs. The user input elements can include, for example, indications of binary feedback regarding the outputs (e.g., good/bad feedback; feedback indicating the outputs do or do not meet the user's criteria, such as criteria regarding technical accuracy or precision); indications of multiple levels of feedback (e.g., scoring the outputs on a predetermined scale, such as a 1-5 scale or 1-10 scale); freeform feedback (e.g., text or audio feedback); or various combinations thereof.

The system 100 can store and/or maintain feedback in the feedback repository 124. In some implementations, the system 100 stores the feedback with one or more data elements associated with the feedback, including but not limited to the outputs for which the feedback was received, the second model(s) 116 used to generate the outputs, and/or input information used by the second models 116 to generate the outputs (e.g., service request information; information captured by the user regarding the item of equipment).

The feedback trainer 128 can update the one or more second models 116 using the feedback. The feedback trainer 128 can be similar to the model updater 108. In some implementations, the feedback trainer 128 is implemented by the model updater 108; for example, the model updater 108 can include or be coupled with the feedback trainer 128. The feedback trainer 128 can perform various configuration operations (e.g., retraining, fine-tuning, transfer learning, etc.) on the second models 116 using the feedback from the feedback repository 124. In some implementations, the feedback trainer 128 identifies one or more first parameters of the second model 116 to maintain as having predetermined values (e.g., freeze the weights and/or biases of one or more first layers of the second model 116), and performs a training process, such as a fine tuning process, to configure parameters of one or more second parameters of the second model 116 using the feedback (e.g., one or more second layers of the second model 116, such as output layers or output heads of the second model 116).

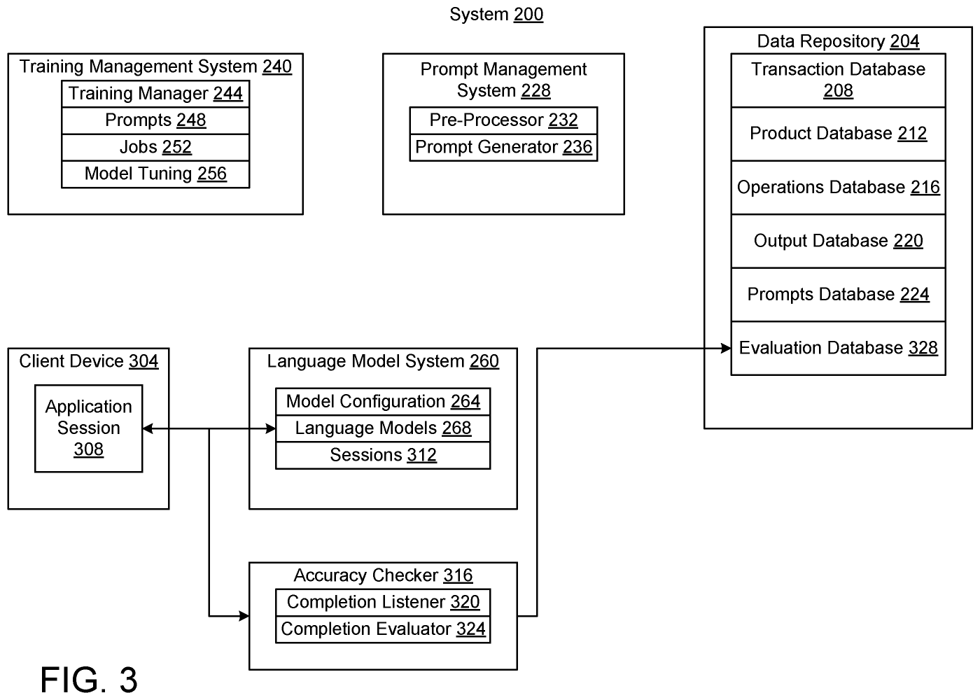

In some implementations, the system 100 may not include and/or use the model updater 108 (or the feedback trainer 128) to determine the second models 116. For example, the system 100 can include or be coupled with an output processor (e.g., an output processor similar or identical to accuracy checker 316 described with reference to FIG. 3) that can evaluate and/or modify outputs from the first model 104 prior to operation of applications 120, including to perform any of various post-processing operations on the output from the first model 104. For example, the output processor can compare outputs of the first model 104 with data from data sources 112 to validate the outputs of the first model 104 and/or modify the outputs of the first model 104 (or output an error) responsive to the outputs not satisfying a validation condition.

### Connected Machine Learning Models

Referring further to FIG. 1, the second model 116 can be coupled with one or more third models, functions, or algorithms for training/configuration and/or runtime operations. The third models can include, for example and without limitation, any of various models relating to items of equipment, such as energy usage models, sustainability models, carbon models, air quality models, or occupant comfort models. For example, the second model 116 can be used to process unstructured information regarding items of equipment into predefined template formats compatible with various third models, such that outputs of the second model 116 can be provided as inputs to the third models; this can allow more accurate training of the third models, more training data to be generated for the third models, and/or more data available for use by the third models. The second model 116 can receive inputs from one or more third models, which can provide greater data to the second model 116 for processing.

### Automated Service Scheduling and Provisioning

The system 100 can be used to automate operations for scheduling, provisioning, and deploying service technicians and resources for service technicians to perform service operations. For example, the system 100 can use at least one of the first model 104 or the second model 116 to determine, based on processing information regarding service operations for items of equipment relative to completion criteria for the service operation, particular characteristics of service operations such as experience parameters of scheduled service technicians, identifiers of parts provided for the service operations, geographical data, types of customers, types of problems, or information content provided to the service technicians to facilitate the service operation, where such characteristics correspond to the completion criteria being satisfied (e.g., where such characteristics correspond to an increase in likelihood of the completion criteria being satisfied relative to other characteristics for service technicians, parts, information content, etc.). For example, the system 100 can determine, for a given item of equipment, particular parts to include on a truck to be sent to the site of the item of equipment. As such, the system 100, responsive to processing inputs at runtime such as service requests, can automatically and more accurately identify service technicians and parts to direct to the item of equipment for the service operations. The system 100 can use timing information to perform batch scheduling for multiple service operations and/or multiple technicians for the same or multiple service operations. The system 100 can perform batch scheduling for multiple trucks for multiple items of equipment, such as to schedule a first one or more parts having a greater likelihood for satisfying the completion criteria for a first item of equipment on a first truck, and a second one or more parts having a greater likelihood for satisfying the completion criteria for a second item of equipment on a second truck.

### II. System Architectures for Generative AI Applications for Building Management System and Equipment Servicing

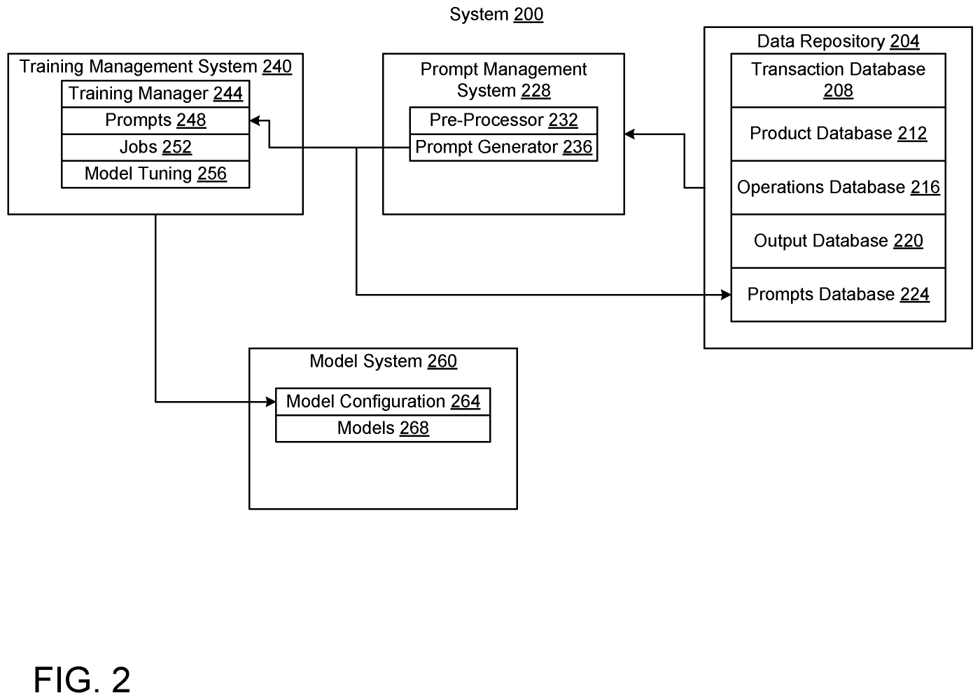

FIG. 2 depicts an example of a system 200. The system 200 can include one or more components or features of the system 100, such as any one or more of the first model 104, data sources 112, second model 116, applications 120, feedback repository 124, and/or feedback trainer 128. The system 200 can perform specific operations to facilitate generative AI applications for building managements systems and equipment servicing, such as various manners of processing input data into training data (e.g., tokenizing input data; forming input data into prompts and/or completions), and managing training and other machine learning model configuration processes. Various components of the system 200 can be implemented using one or more computer systems, which may be provided on the same or different processors (e.g., processors communicatively coupled via wired and/or wireless connections).

The system 200 can include at least one data repository 204, which can be similar to the data sources 112 described with reference to FIG. 1. For example, the data repository 204 can include a transaction database 208, which can be similar or identical to one or more of warranty data or service data of data sources 112. For example, the transaction database 208 can include data such as parts used for service transactions; sales data indicating various service transactions or other transactions regarding items of equipment; warranty and/or claims data regarding items of equipment; and service data.

The data repository 204 can include a product database 212, which can be similar or identical to the parts data of the data sources 112. The product database 212 can include, for example, data regarding products available from various vendors, specifications or parameters regarding products, and indications of products used for various service operations. The products database 212 can include data such as events or alarms associated with products; logs of product operation; and/or time series data regarding product operation, such as longitudinal data values of operation of products and/or building equipment.

The data repository 204 can include an operations database 216, which can be similar or identical to the operations data of the data sources 112. For example, the operations database 216 can include data such as manuals regarding parts, products, and/or items of equipment; customer service data; and or reports, such as operation or service logs.

In some implementations, the data repository 204 can include an output database 220, which can include data of outputs that may be generated by various machine learning models and/or algorithms. For example, the output database 220 can include values of pre-calculated predictions and/or insights, such as parameters regarding operation items of equipment, such as setpoints, changes in setpoints, flow rates, control schemes, identifications of error conditions, or various combinations thereof.

As depicted in FIG. 2, the system 200 can include a prompt management system 228. The prompt management system 228 can include one or more rules, heuristics, logic, policies, algorithms, functions, machine learning models, neural networks, scripts, or various combinations thereof to perform operations including processing data from data repository 204 into training data for configuring various machine learning models. For example, the prompt management system 228 can retrieve and/or receive data from the data repository 228, and determine training data elements that include examples of input and outputs for generation by machine learning models, such as a training data element that includes a prompt and a completion corresponding to the prompt, based on the data from the data repository 228.

In some implementations, the prompt management system 228 includes a pre-processor 232. The pre-processor 232 can perform various operations to prepare the data from the data repository 204 for prompt generation. For example, the pre-processor 232 can perform any of various filtering, compression, tokenizing, or combining (e.g., combining data from various databases of the data repository 204) operations.

The prompt management system 228 can include a prompt generator 236. The prompt generator 236 can generate, from data of the data repository 204, one or more training data elements that include a prompt and a completion corresponding to the prompt. In some implementations, the prompt generator 236 receives user input indicative of prompt and completion portions of data. For example, the user input can indicate template portions representing prompts of structured data, such as predefined fields or forms of documents, and corresponding completions provided for the documents. The user input can assign prompts to unstructured data. In some implementations, the prompt generator 236 automatically determines prompts and completions from data of the data repository 204, such as by using any of various natural language processing algorithms to detect prompts and completions from data. In some implementations, the system 200 does not identify distinct prompts and completions from data of the data repository 204.

Referring further to FIG. 2, the system 200 can include a training management system 240. The training management system 240 can include one or more rules, heuristics, logic, policies, algorithms, functions, machine learning models, neural networks, scripts, or various combinations thereof to perform operations including controlling training of machine learning models, including performing fine tuning and/or transfer learning operations.

The training management system 240 can include a training manager 244. The training manager 244 can incorporate features of at least one of the model updater 108 or the feedback trainer 128 described with reference to FIG. 1. For example, the training manager 244 can provide training data including a plurality of training data elements (e.g., prompts and corresponding completions) to the model system 260 as described further herein to facilitate training machine learning models.

In some implementations, the training management system 240 includes a prompts database 248. For example, the training management system 240 can store one or more training data elements from the prompt management system 228, such as to facilitate asynchronous and/or batched training processes.

The training manager 244 can control the training of machine learning models using information or instructions maintained in a model tuning database 256. For example, the training manager 244 can store, in the model tuning database 256, various parameters or hyperparameters for models and/or model training.

In some implementations, the training manager 244 stores a record of training operations in a jobs database 252. For example, the training manager 244 can maintain data such as a queue of training jobs, parameters or hyperparameters to be used for training jobs, or information regarding performance of training.

Referring further to FIG. 2, the system 200 can include at least one model system 260 (e.g., one or more language model systems). The model system 260 can include one or more rules, heuristics, logic, policies, algorithms, functions, machine learning models, neural networks, scripts, or various combinations thereof to perform operations including configuring one or more machine learning models 268 based on instructions from the training management system 240. In some implementations, the training management system 240 implements the model system 260. In some implementations, the training management system 240 can access the model system 260 using one or more APIs, such as to provide training data and/or instructions for configuring machine learning models 268 via the one or more APIs. The model system 260 can operate as a service layer for configuring the machine learning models 268 responsive to instructions from the training management system 240. The machine learning models 268 can be or include the first model 104 and/or second model 116 described with reference to FIG. 1.

The model system 260 can include a model configuration processor 264. The model configuration processor 264 can incorporate features of the model updater 108 and/or the feedback trainer 128 described with reference to FIG. 1. For example, the model configuration processor 264 can apply training data (e.g., prompts 248 and corresponding completions) to the machine learning models 268 to configure (e.g., train, modify, update, fine-tune, etc.) the machine learning models 268. The training manager 244 can control training by the model configuration processor 264 based on model tuning parameters in the model tuning database 256, such as to control various hyperparameters for training. In various implementations, the system 200 can use the training management system 240 to configure the machine learning models 268 in a similar manner as described with reference to the second model 116 of FIG. 1, such as to train the machine learning models 268 using any of various data or combinations of data from the data repository 204.

### Application Session Management

FIG. 3 depicts an example of the system 200, in which the system 200 can perform operations to implement at least one application session 308 for a client device 304. For example, responsive to configuring the machine learning models 268, the system 200 can generate data for presentation by the client device 304 (including generating data responsive to information received from the client device 304) using the at least one application session 308 and the one or more machine learning models 268.

The client device 304 can be a device of a user, such as a technician or building manager. The client device 304 can include any of various wireless or wired communication interfaces to communicate data with the model system 260, such as to provide requests to the model system 260 indicative of data for the machine learning models 268 to generate, and to receive outputs from the model system 260. The client device 304 can include various user input and output devices to facilitate receiving and presenting inputs and outputs.

In some implementations, the system 200 provides data to the client device 304 for the client device 304 to operate the at least one application session 308. The application session 308 can include a session corresponding to any of the applications 120 described with reference to FIG. 1. For example, the client device 304 can launch the application session 308 and provide an interface to request one or more prompts. Responsive to receiving the one or more prompts, the application session 308 can provide the one or more prompts as input to the machine learning model 268. The machine learning model 268 can process the input to generate a completion, and provide the completion to the application session 308 to present via the client device 304. In some implementations, the application session 308 can iteratively generate completions using the machine learning models 268. For example, the machine learning models 268 can receive a first prompt from the application session 308, determine a first completion based on the first prompt and provide the first completion to the application session 308, receive a second prompt from the application 308, determine a second completion based on the second prompt (which may include at least one of the first prompt or the first completion concatenated to the second prompt), and provide the second completion to the application session 308.

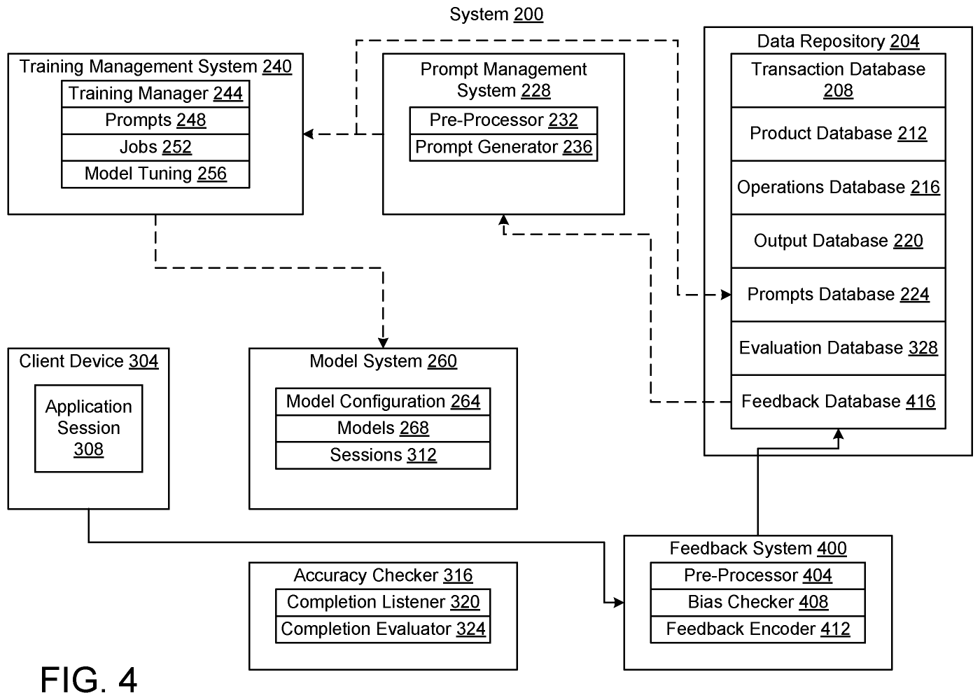

In some implementations, the model system 260 includes at least one sessions database 312. The sessions database 312 can maintain records of application session 308 implemented by client devices 304. For example, the sessions database 312 can include records of prompts provided to the machine learning models 268 and completions generated by the machine learning models 268. As described further with reference to FIG. 4, the system 200 can use the data in the sessions database 312 to fine-tune or otherwise update the machine learning models 268.

### Completion Checking

In some implementations, the system 200 includes an accuracy checker 316. The accuracy checker 316 can include one or more rules, heuristics, logic, policies, algorithms, functions, machine learning models, neural networks, scripts, or various combinations thereof to perform operations including evaluating performance criteria regarding the completions determined by the model system 260. For example, the accuracy checker 316 can include at least one completion listener 320. The completion listener 320 can receive the completions determined by the model system 320 (e.g., responsive to the completions being generated by the machine learning model 268 and/or by retrieving the completions from the sessions database 312).

The accuracy checker 316 can include at least one completion evaluator 324. The completion evaluator 324 can evaluate the completions (e.g., as received or retrieved by the completion listener 320) according to various criteria. In some implementations, the completion evaluator 324 evaluates the completions by comparing the completions with corresponding data from the data repository 204. For example, the completion evaluator 324 can identify data of the data repository 204 having similar text as the prompts and/or completions (e.g., using any of various natural language processing algorithms), and determine whether the data of the completions is within a range of expected data represented by the data of the data repository 204.

In some implementations, the accuracy checker 316 can store an output from evaluating the completion (e.g., an indication of whether the completion satisfies the criteria) in an evaluation database 328. For example, the accuracy checker 316 can assign the output (which may indicate at least one of a binary indication of whether the completion satisfied the criteria or an indication of a portion of the completion that did not satisfy the criteria) to the completion for storage in the evaluation database 328, which can facilitate further training of the machine learning models 268 using the completions and output.

### Feedback Training

FIG. 4 depicts an example of the system 200 that includes a feedback system 400, such as a feedback aggregator. The feedback system 400 can include one or more rules, heuristics, logic, policies, algorithms, functions, machine learning models, neural networks, scripts, or various combinations thereof to perform operations including preparing data for updating and/or updating the machine learning models 268 using feedback corresponding to the application sessions 308, such as feedback received as user input associated with outputs presented by the application sessions 308. The feedback system 400 can incorporate features of the feedback repository 124 and/or feedback trainer 128 described with reference to FIG. 1.

The feedback system 400 can receive feedback (e.g., from the client device 304) in various formats. For example, the feedback can include any of text, speech, audio, image, and/or video data. The feedback can be associated (e.g., in a data structure generated by the application session 308) with the outputs of the machine learning models 268 for which the feedback is provided. The feedback can be received or extracted from various forms of data, including external data sources such as manuals, service reports, or Wikipedia-type documentation.

In some implementations, the feedback system 400 includes a pre-processor 400. The pre-processor 400 can perform any of various operations to modify the feedback for further processing. For example, the pre-processor 400 can incorporate features of, or be implemented by, the pre-processor 232, such as to perform operations including filtering, compression, tokenizing, or translation operations (e.g., translation into a common language of the data of the data repository 204).

The feedback system 400 can include a bias checker 408. The bias checker 408 can evaluate the feedback using various bias criteria, and control inclusion of the feedback in a feedback database 416 (e.g., a feedback database 416 of the data repository 204 as depicted in FIG. 4) according to the evaluation. The bias criteria can include, for example and without limitation, criteria regarding qualitative and/or quantitative differences between a range or statistic measure of the feedback relative to actual, expected, or validated values.

The feedback system 400 can include a feedback encoder 412. The feedback encoder 412 can process the feedback (e.g., responsive to bias checking by the bias checker 408) for inclusion in the feedback database 416. For example, the feedback encoder 412 can encode the feedback as values corresponding to outputs scoring determined by the model system 260 while generating completions (e.g., where the feedback indicates that the completion presented via the application session 308 was acceptable, the feedback encoder 412 can encode the feedback by associating the feedback with the completion and assigning a relatively high score to the completion).

As indicated by the dashed arrows in FIG. 4, the feedback can be used by the prompt management system 228 and training management system 240 to further update one or more machine learning models 268. For example, the prompt management system 228 can retrieve at least one feedback (and corresponding prompt and completion data) from the feedback database 416, and process the at least one feedback to determine a feedback prompt and feedback completion to provide to the training management system 240 (e.g., using pre-processor 232 and/or prompt generator 236, and assigning a score corresponding to the feedback to the feedback completion). The training manager 244 can provide instructions to the model system 260 to update the machine learning models 268 using the feedback prompt and the feedback completion, such as to perform a fine-tuning process using the feedback prompt and the feedback completion. In some implementations, the training management system 240 performs a batch process of feedback-based fine tuning by using the prompt management system 228 to generate a plurality of feedback prompts and a plurality of feedback completion, and providing instructions to the model system 260 to perform the fine-tuning process using the plurality of feedback prompts and the plurality of feedback completions.

### Data Filtering and Validation Systems

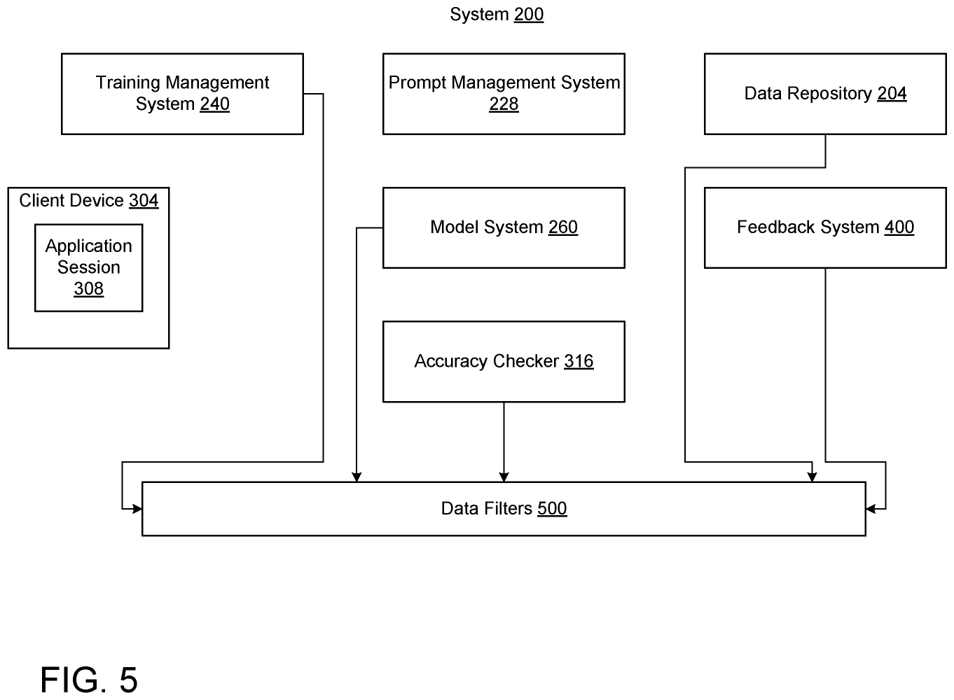

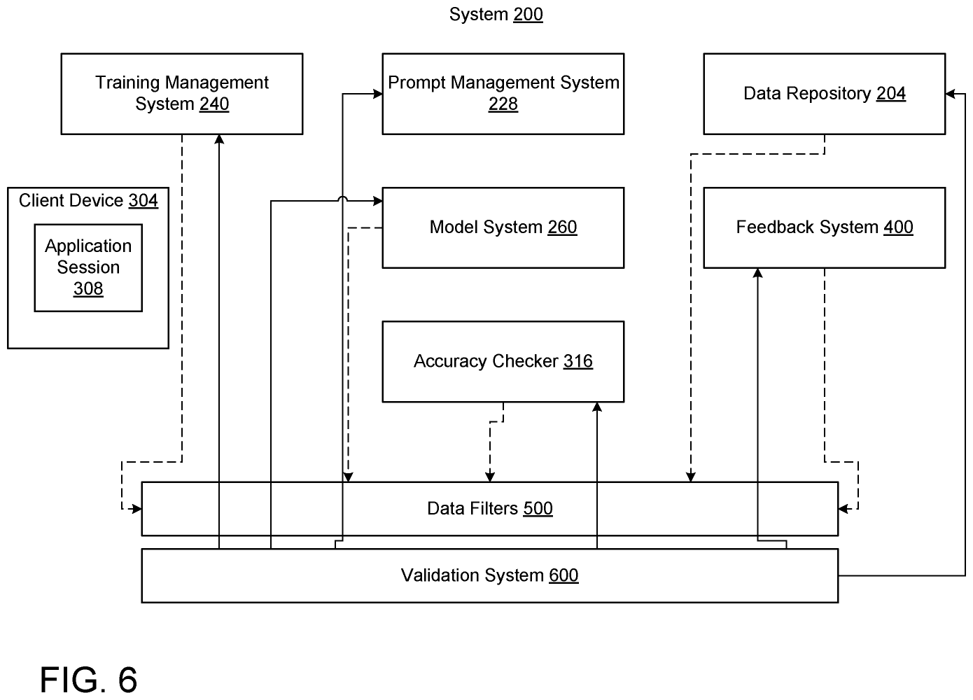

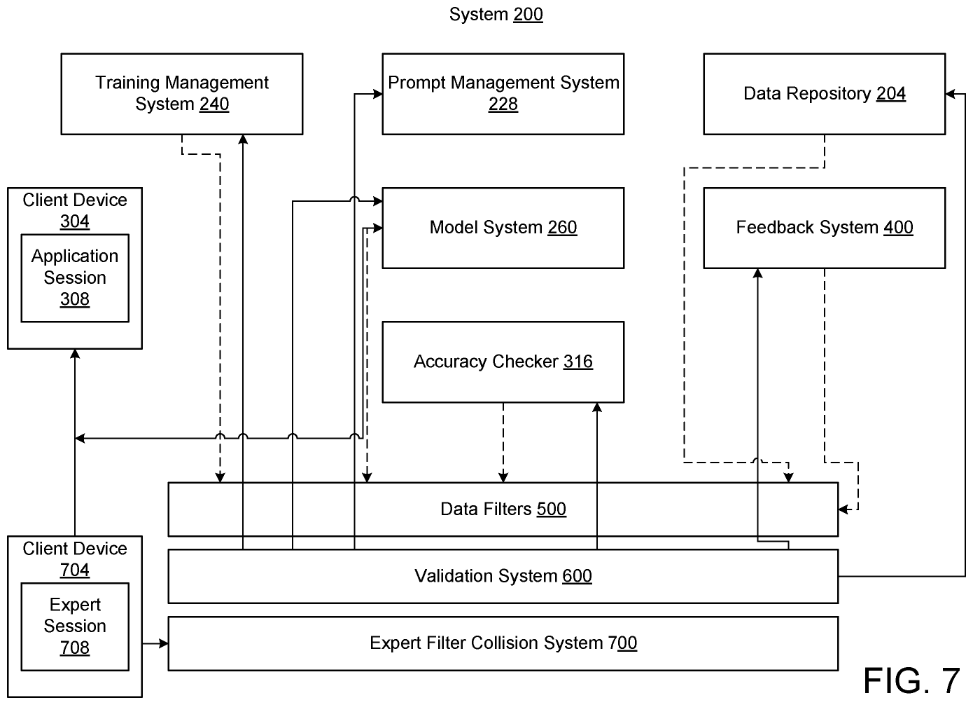

FIG. 5 depicts an example of the system 200, where the system 200 can include one or more data filters 500 (e.g., data validators). The data filters 500 can include any one or more rules, heuristics, logic, policies, algorithms, functions, machine learning models, neural networks, scripts, or various combinations thereof to perform operations including modifying data processed by the system 200 and/or triggering alerts responsive to the data not satisfying corresponding criteria, such as thresholds for values of data. Various data filtering processes described with reference to FIG. 5 (as well as FIGS. 6 and 7) can facilitate the system 200 to implement timely operations for improving the precision and/or accuracy of completions or other information generated by the system 200 (e.g., including improving the accuracy of feedback data used for fine-tuning the machine learning models 268). The data filters 500 can allow for interactions between various algorithms, models, and computational processes.

For example, the data filters 500 can be used to evaluate data relative to thresholds relating to data including, for example and without limitation, acceptable data ranges, setpoints, temperatures, pressures, flow rates (e.g., mass flow rates), or vibration rates for an item of equipment. The threshold can include any of various thresholds, such as one or more of minimum, maximum, absolute, relative, fixed band, and/or floating band thresholds.

The data filters 500 can facilitate the system 200 to detect when data, such as prompts, completions, or other inputs and/or outputs of the system 200, collide with thresholds that represent realistic behavior or operation or other limits of items of equipment. For example, the thresholds of the data filters 500 can correspond to values of data that are within feasible or recommended operating ranges. In some implementations, the system 200 determines or receives the thresholds using models or simulations of items of equipment, such as plant or equipment simulators, chiller models, HVAC-R models, refrigeration cycle models, etc. The system 200 can receive the thresholds as user input (e.g., from experts, technicians, or other users). The thresholds of the data filters 500 can be based on information from various data sources. The thresholds can include, for example and without limitation, thresholds based on information such as equipment limitations, safety margins, physics, expert teaching, etc. For example, the data filters 500 can include thresholds determined from various models, functions, or data structures (e.g., tables) representing physical properties and processes, such as physics of psychometrics, thermodynamics, and/or fluid dynamics information.

The system 200 can determine the thresholds using the feedback system 400 and/or the client device 304, such as by providing a request for feedback that includes a request for a corresponding threshold associated with the completion and/or prompt presented by the application session 308. For example, the system 200 can use the feedback to identify realistic thresholds, such as by using feedback regarding data generated by the machine learning models 268 for ranges, setpoints, and/or start-up or operating sequences regarding items of equipment (and which can thus be validated by human experts). In some implementations, the system 200 selectively requests feedback indicative of thresholds based on an identifier of a user of the application session 308, such as to selectively request feedback from users having predetermined levels of expertise and/or assign weights to feedback according to criteria such as levels of expertise.

In some implementations, one or more data filters 500 correspond to a given setup. For example, the setup can represent a configuration of a corresponding item of equipment (e.g., configuration of a chiller, etc.). The data filters 500 can represent various thresholds or conditions with respect to values for the configuration, such as feasible or recommendation operating ranges for the values. In some implementations, one or more data filters 500 correspond to a given situation. For example, the situation can represent at least one of an operating mode or a condition of a corresponding item of equipment.

FIG. 5 depicts some examples of data (e.g., inputs, outputs, and/or data communicated between nodes of machine learning models 268) to which the data filters 500 can be applied to evaluate data processed by the system 200 including various inputs and outputs of the system 200 and components thereof. This can include, for example and without limitation, filtering data such as data communicated between one or more of the data repository 204, prompt management system 228, training management system 240, model system 260, client device 304, accuracy checker 316, and/or feedback system 400. For example, the data filters 500 (as well as validation system 600 described with reference to FIG. 6 and/or expert filter collision system 700 described with reference to FIG. 7) can receive data outputted from a source (e.g., source component) of the system 200 for receipt by a destination (e.g., destination component) of the system 200, and filter, modify, or otherwise process the outputted data prior to the system 200 providing the outputted data to the destination. The sources and destinations can include any of various combinations of components and systems of the system 200.

The system 200 can perform various actions responsive to the processing of data by the data filters 500. In some implementations, the system 200 can pass data to a destination without modifying the data (e.g., retaining a value of the data prior to evaluation by the data filter 500) responsive to the data satisfying the criteria of the respective data filter(s) 500. In some implementations, the system 200 can at least one of (i) modify the data or (ii) output an alert responsive to the data not satisfying the criteria of the respective data filter(s) 500. For example, the system 200 can modify the data by modifying one or more values of the data to be within the criteria of the data filters 500.

In some implementations, the system 200 modifies the data by causing the machine learning models 268 to regenerate the completion corresponding to the data (e.g., for up to a predetermined threshold number of regeneration attempts before triggering the alert). This can facilitate the data filters 500 and the system 200 selectively trigger alerts responsive to determining that the data (e.g., the collision between the data and the thresholds of the data filters 500) may not be repairable by the machine learning model 268 aspects of the system 200.

The system 200 can output the alert to the client device 304. The system 200 can assign a flag corresponding to the alert to at least one of the prompt (e.g., in prompts database 224) or the completion having the data that triggered the alert.

FIG. 6 depicts an example of the system 200, in which a validation system 600 is coupled with one or more components of the system 200, such as to process and/or modify data communicated between the components of the system 200. For example, the validation system 600 can provide a validation interface for human users (e.g., expert supervisors, checkers) and/or expert systems (e.g., data validation systems that can implement processes analogous to those described with reference to the data filters 500) to receive data of the system 200 and modify, validate, or otherwise process the data. For example, the validation system 600 can provide to human expert supervisors, human checkers, and/or expert systems various data of the system 200, receive responses to the provided data indicating requested modifications to the data or validations of the data, and modify (or validate) the provided data according to the responses.

For example, the validation system 600 can receive data such as data retrieved from the data repository 204, prompts outputted by the prompt management system 228, completions outputted by the model system 260, indications of accuracy outputted by the accuracy checker 316, etc., and provide the received data to at least one of an expert system or a user interface. In some implementations, the validation system 600 receives a given item of data prior to the given item of data being processed by the model system 260, such as to validate inputs to the machine learning models 268 prior to the inputs being processed by the machine learning models 268 to generate outputs, such as completions.

In some implementations, the validation system 600 validates data by at least one of (i) assigning a label (e.g., a flag, etc.) to the data indicating that the data is validated or (ii) passing the data to a destination without modifying the data. For example, responsive to receiving at least one of a user input (e.g., from a human validator/supervisor/expert) that the data is valid or an indication from an expert system that the data is valid, the validation system 600 can assign the label and/or provide the data to the destination.

The validation system 600 can selectively provide data from the system 200 to the validation interface responsive to operation of the data filters 500. This can facilitate the validation system 600 to trigger validation of the data responsive to collision of the data with the criteria of the data filters 500. For example, responsive to the data filters 500 determining that an item of data does not satisfy a corresponding criteria, the data filters 500 can provide the item of data to the validation system 600. The data filters 500 can assign various labels to the item of data, such as indications of the values of the thresholds that the data filters 500 used to determine that the item of data did not satisfy the thresholds. Responsive to receiving the item of data from the data filters 500, the validation system 600 can provide the item of data to the validation interface (e.g., to a user interface of client device 304 and/or application session 308; for comparison with a model, simulation, algorithm, or other operation of an expert system) for validation. In some implementations, the validation system 600 can receive an indication that the item of data is valid (e.g., even if the item of data did not satisfy the criteria of the data filters 500) and can provide the indication to the data filters 500 to cause the data filters 500 to at least partially modify the respective thresholds according to the indication.

In some implementations, the validation system 600 selectively retrieves data for validation where (i) the data is determined or outputted prior to use by the machine learning models 268, such as data from the data repository 204 or the prompt management system 228, or (ii) the data does not satisfy a respective data filter 500 that processes the data. This can facilitate the system 200, the data filters 500, and the validation system 600 to update the machine learning models 268 and other machine learning aspects (e.g., generative AI aspects) of the system 200 to more accurately generate data and completions (e.g., enabling the data filters 500 to generate alerts that are received by the human experts/expert systems that may be repairable by adjustments to one or more components of the system 200).

FIG. 7 depicts an example of the system 200, in which an expert filter collision system 700 (“expert system” 700) can facilitate providing feedback and providing more accurate and/or precise data and completions to a user via the application session 308. For example, the expert system 700 can interface with various points and/or data flows of the system 200, as depicted in FIG. 7, where the system 200 can provide data to the expert filter collision system 700, such as to transmit the data to a user interface and/or present the data via a user interface of the expert filter collision system 700 that can accessed via an expert session 708 of a client device 704. For example, via the expert session 708, the expert session 700 can facilitate functions such as receiving inputs for a human expert to provide feedback to a user of the client device 304; a human expert to guide the user through the data (e.g., completions) provided to the client device 304, such as reports, insights, and action items; a human expert to review and/or provide feedback for revising insights, guidance, and recommendations before being presented by the application session 308; a human expert to adjust and/or validate insights or recommendations before they are viewed or used for actions by the user; or various combinations thereof. In some implementations, the expert system 700 can use feedback received via the expert session as inputs to update the machine learning models 268 (e.g., to perform fine-tuning).

In some implementations, the expert system 700 retrieves data to be provided to the application session 308, such as completions generated by the machine learning models 268. The expert system 700 can present the data via the expert session 708, such as to request feedback regarding the data from the client device 704. For example, the expert system 700 can receive feedback regarding the data for modifying or validating the data (e.g., editing or validating completions). In some implementations, the expert system 700 requests at least one of an identifier or a credential of a user of the client device 704 prior to providing the data to the client device 704 and/or requesting feedback regarding the data from the expert session 708. For example, the expert system 700 can request the feedback responsive to determining that the at least one of the identifier or the credential satisfies a target value for the data. This can allow the expert system 708 to selectively identify experts to use for monitoring and validating the data.

In some implementations, the expert system 700 facilitates a communication session regarding the data, between the application session 308 and the expert session 708. For example, the expert session 700, responsive to detecting presentation of the data via the application session 308, can request feedback regarding the data (e.g., user input via the application session 308 for feedback regarding the data), and provide the feedback to the client device 704 to present via the expert session 708. The expert session 708 can receive expert feedback regarding at least one of the data or the feedback from the user to provide to the application session 308. In some implementations, the expert system 700 can facilitate any of various real-time or asynchronous messaging protocols between the application session 308 and expert session 708 regarding the data, such as any of text, speech, audio, image, and/or video communications or combinations thereof. This can allow the expert system 700 to provide a platform for a user receiving the data (e.g., customer or field technician) to receive expert feedback from a user of the client device 704 (e.g., expert technician). In some implementations, the expert system 700 stores a record of one or more messages or other communications between the sessions 308, 708 in the data repository 204 to facilitate further configuration of the machine learning models 268 based on the interactions between the users of the sessions 308, 708.

### Building Data Platforms and Digital Twin Architectures

Referring further to FIGS. 1-7, various systems and methods described herein can be executed by and/or communicate with building data platforms, including data platforms of building management systems. For example, the data repository 204 can include or be coupled with one or more building data platforms, such as to ingest data from building data platforms and/or digital twins. The client device 304 can communicate with the system 200 via the building data platform, and can feedback, reports, and other data to the building data platform. In some implementations, the data repository 204 maintains building data platform-specific databases, such as to facilitate the system 200 to configure the machine learning models 268 on a building data platform-specific basis (or on an entity-specific basis using data from one or more building data platforms maintained by the entity).

For example, in some implementations, various data discussed herein may be stored in, retrieved from, or processed in the context of building data platforms and/or digital twins; processed at (e.g., processed using models executed at) a cloud or other off-premises computing system/device or group of systems/devices, an edge or other on-premises system/device or group of systems/devices, or a hybrid thereof in which some processing occurs off-premises and some occurs on-premises; and/or implemented using one or more gateways for communication and data management amongst various such systems/devices. In some such implementations, the building data platforms and/or digital twins may be provided within an infrastructure such as those described in U.S. patent application Ser. No. 17/134,661 filed Dec. 28, 2020, Ser. No. 18/080,360, filed Dec. 13, 2022, Ser. No. 17/537,046 filed Nov. 29, 2021, and Ser. No. 18/096,965, filed Jan. 13, 2023, and Indian patent application No. 202341008712, filed Feb. 10, 2023, the disclosures of which are incorporated herein by reference in their entireties.

### III. Generative AI-Based Systems and Methods for Equipment Servicing

As described above, systems and methods in accordance with the present disclosure can use machine learning models, including LLMs and other generative AI models, to ingest data regarding building management systems and equipment in various unstructured and structured formats, and generate completions and other outputs targeted to provide useful information to users. Various systems and methods described herein can use machine learning models to support applications for presenting data with high accuracy and relevance.

### Equipment Service Management Responsive to Fault Detection Using Machine Learning Models

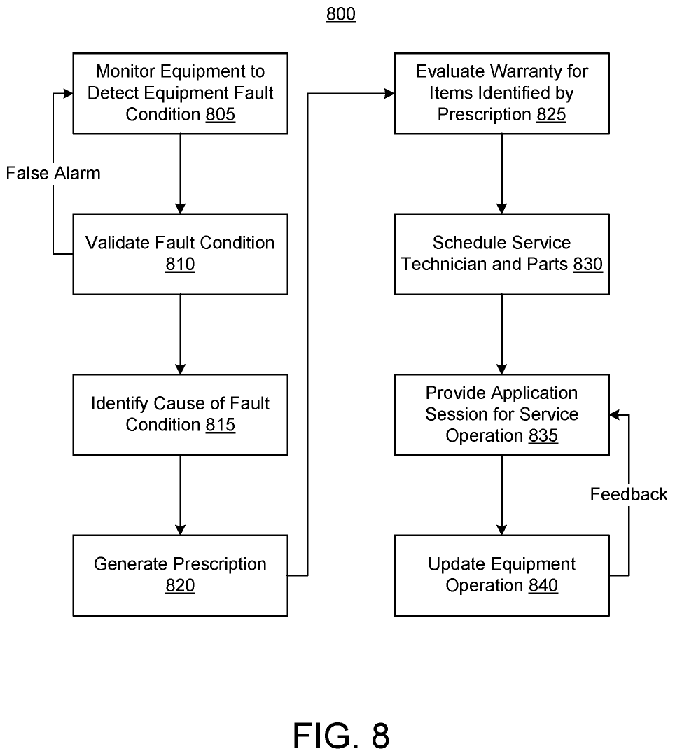

FIG. 8 depicts an example of a method 800. The method 800 can be performed using various devices and systems described herein, including but not limited to the systems 100, 200 or one or more components thereof. Various aspects of the method 800 can be implemented using one or more devices or systems that are communicatively coupled with one another, including in client-server, cloud-based, or other networked architectures.

At 805, a fault condition of an item of equipment can be detected. The fault condition can be detected responsive to manual and/or automated monitoring of various data sources regarding the item of equipment. In some implementations, the fault condition is detected responsive to an alarm notification from an alarm of the equipment or coupled with the equipment. For example, sensor data of the equipment or from a sensor directed to the equipment can be monitored by the alarm, and evaluated according to one or more alarm conditions (e.g., threshold values) to trigger the alarm notification. The fault condition can be detected responsive to user input indicative of the fault condition, or images or other data received indicative of the fault condition.

At 810, the fault condition can be validated. For example, the fault condition can be validated to determine whether the alarm notification corresponds to a false alarm. In some implementations, the fault condition can be validated by verifying the data used to detect the fault condition at a second point in time (e.g., subsequent to a first point in time at which the fault condition was initially detected), such as by evaluating the one or more alarm conditions using data regarding the equipment at the second point in time; this may include using the same or different data than the data used to initially detect the fault condition to validate the fault condition. The fault condition can be validated by providing the alarm notification to a device of a user, and requesting a confirmation (or indication of false alarm) from the user via the device. Responsive to the fault condition being identified as a false alarm, the equipment can be continued to be monitored.

At 815, a cause of the fault condition can be identified, such as by performing a root cause analysis. In some implementations, the cause is detected using a function that includes one or more algorithms, tables, simulations, or machine learning models described herein. For example, at least one of an identifier of the equipment, the fault condition, user text or speech identifying the fault condition (e.g., notes from any of a variety of entities, such as a facility manager, on-site technician, etc.), or data regarding the equipment used to detect the fault condition can be applied as input to the function to facilitate the function to determine an indication of a cause of the fault condition. For example, the function can include a table mapping various such inputs to one or more causes of fault conditions. The function can include a machine learning model configured using various forms of data described herein. For example, the machine learning model can include one or more classifiers, language models, or combinations thereof that are trained using data that includes information indicative of fault conditions and associated causes of fault conditions.

At 820, a prescription is generated based on the cause of the fault condition. For example, one or more of the cause of the fault condition, the fault condition, and an identifier of the equipment can be provided to a language model to cause the language model to generate the prescription. The prescription can have a natural language format. The prescription can indicate one or more actions for a service technician to perform to verify, service, and/or repair the fault condition, such as instructions for tools and/or parts to use for the item of equipment. The language model can include any of various models described herein that are configured, using training data representative of prescriptions. The prescription can be generated for presentation using various output modalities, such as text, speech, audio, image, and/or video, including in real-time, conversational, or asynchronous formats.

In some implementations, generating the prescription includes conditioning or guiding the language model to generate the prescription based on a class of at least one of the service technician or the site at which the item of equipment is present. For example, the language model can have its configuration (e.g., training, etc.) modified according to labels of identifiers or classes of technicians, sites, types of equipment, or other characteristics relating to the item of equipment and/or the service technician, which can facilitate the prescription to be generated in a manner that is more accurate and/or relevant to the service to be performed.

At 825, a warranty is evaluated based on one or more items (e.g., the equipment, parts or tools for servicing the equipment) identified by the prescription. For example, the warranty can be retrieved from various sources, such as a contract database associated with the entity that maintains the site, according to an identifier of the type of equipment, from the service request, or various combinations thereof. The prescription (or the service request) can be parsed to identify one or more items, such as items of equipment, identified by the prescription. For example, the item of equipment for which the service request is generated can be identified from the prescription, and compared with the warranty (e.g., using natural language processing algorithms, etc.) to identify one or more warranty conditions assigned to the item of equipment. The warranty conditions can indicate, for example, timing criteria for authorizing and/or payment for servicing the item of equipment by a vendor or supplier of the item of equipment. Responsive to the warranty conditions being satisfied (e.g., a termination of the warranty not being met), various actions can be performed to trigger servicing of the item of equipment. In some implementations, one or more warranty conditions are evaluated prior to, during, and or subsequent to generation of the prescription, such as to allow the prescription to be generated to incorporate one or more outputs of the evaluation of the warranty (or avoid computational resources for generating the prescription responsive to the warranty conditions not being satisfied).

At 830, scheduling of deployment of at least one of a service technician or one or more parts identified by the prescription can be performed. In some implementations, the prescription can identify the service technician, such as to select the service technician from a plurality of candidate service technicians according to an expertise that the service technician is labeled with and which corresponds to the item of equipment. Scheduling deployment of the one or more parts can including identifying a provider of the one or more parts and assigning the one or more parts to a vehicle (e.g., trucks) for delivering the one or more parts to the site of the item of equipment. By using the language model to generate the prescription—which identifies the one or more parts—the one or more parts that are delivered to the site can be more accurately identified, which can reduce resource usage and/or wasted space or weight on the vehicle. In some implementations, scheduling deployment includes generating a service ticket indicative of the service to be performed, such as to identify the service technician, the parts, and/or the item of equipment.

Depending on the determined prescription, the scheduling can include automated servicing of the item of equipment, such as to provide commands to adjust parameters of the item of equipment to a controller of the item of equipment. The scheduling can include providing instructions for performing remote service, such as to provide instructions to a service technician to use on-site tools and/or parts, or manual adjustment of the item of equipment, to service the item of equipment (e.g., to avoid a truck deployment or truck roll to the site).

At 835, an application session for a service operation corresponding to the service request (and the prescription) can be provided. In some implementations, the application session is provided via a device of the service technician. For example, the device can provide one or more credentials to access the application session (e.g., credentials that uniquely identify the service technician). The application session can present information to the service technician in any of various conversational, messaging, graphical, real-time, and/or asynchronous formats. The application session can receive one or more prompts from the device (e.g., from a user input device of the device), and provide the one or more prompts to the language model to cause the language model to provide corresponding completions responsive to the one or more prompts. For example, the device can receive text or image data (among other formats) as inputs provided by actions of the user (e.g., via an input interface of the device; by the user controlling a camera of the device), and provide the inputs as prompts to the language model. The application session can present the completions via the device to facilitate guiding the service technician through the actions to perform to service the item of equipment. In some implementations, the application session automatically (e.g., responsive to detecting a condition for escalating the guidance to a human expert) or manually (e.g., responsive to user input requesting guidance from a human expert) can establish a communication session between the device and a device of a human expert to provide further guidance to the service technician; the language model can provide various information such as the service request, prescription, and/or communications between the user and the language model via the application session to the device of the human expert, and can label various portions of the communications as potential causes of the escalation. The application session can be implemented as a virtual assistant, such as to provide information such as instruction manuals or technical reports regarding the item of equipment, responsive to requests from the service technician inputted at the device of the service technician.

At 840, operation of the item of equipment can be updated responsive to one or more actions performed by the service technician. For example, various parameters of operation of the item of equipment, such as setpoints, can be updated according to the one or more actions.

In some implementations, information from the service request, prescription, and application session processes can be used to perform analytics regarding entities that maintain sites and items of equipment (e.g., to evaluate customer churn). For example, information including unstructured data (e.g., service reports) regarding items of equipment and entity engagement or disengagement (e.g., deals) can be correlated to identify patterns regarding ways that service can be performed to maintain or increase the likelihood of increasing performance of one or more items of equipment of the entity, completion of deals or of maintaining engagement with the entity.

### Information Modeling to Generate Completions Using Machine Learning Models

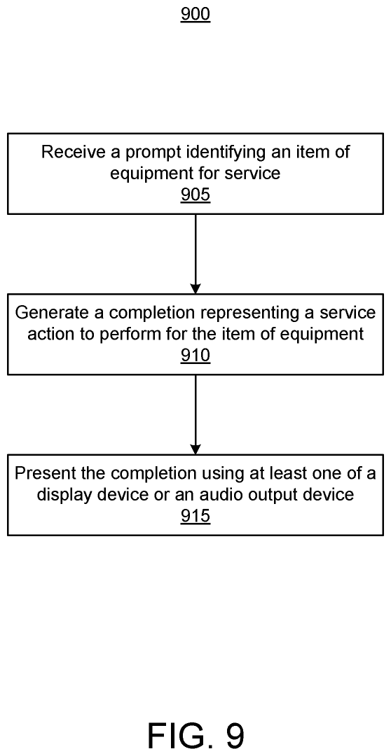

FIG. 9 depicts an example of a method 900. The method 900 can be performed using various devices and systems described herein, including but not limited to the systems 100, 200 or one or more components thereof. Various aspects of the method 900 can be implemented using one or more devices or systems that are communicatively coupled with one another, including in client-server, cloud-based, or other networked architectures.

In general, method 900 relates to the use of a generative AI model that utilizes machine learning and natural language processing to improve building management. By training this AI model with varied datasets, such as training modules and domain-specific information from installers and service professionals, the processing circuits can generate actionable guidance tailored to the requirements of the BMS. For example, the accumulated knowledge can be presented in the form of a conversational handbook or training guide for building managers, allowing them to make informed decisions about their building operations.

The method 900 can include receiving, from a device associated with a user identifier, a prompt for generating data regarding a building management system. The one or more processing circuits executing one or more machine learning models, including but not limited to a generative AI model, can generate a completion indicating one or more actions corresponding to a performance target for the building management system. The completion can then be presented using a display device or an audio output device.

At block 905, a prompt identifying an item of equipment for service can be received. In some implementations, a user or monitoring system can provide a prompt identifying a specific piece of equipment in need of maintenance, repair, or some other service action. In various implementations, the identified equipment could be a large-scale commercial heating, ventilation, and air conditioning unit, a residential HVAC appliance, depending on the scope of the system's implementation. For example, the prompt can specify issues with an air handling unit (AHU), such as inefficiency in air circulation or abnormal noise, which the processing circuits would interpret to provide an appropriate service action. In another example, the prompt can indicate that a particular variable air volume (VAV) box isn't accurately responding to thermostat settings, leading to temperature imbalances in the zone it services, which the processing circuits would interpret to provide an appropriate service action (e.g., corrective measure).

In various implementations, the processing circuits can process the prompt to identify the equipment and/or determine a service to performed according to the prompt. Through a combination of natural language processing and machine learning algorithms, the processing circuits can understand the nature of the prompt, regardless of its source. For example, the processing circuits can decode instructions and extract the information to respond appropriately. Responsive to receiving and/or processing the prompt, the processing circuits can use this information to query an AI model's database (e.g., data sources 112 for similar past service instances). For example, querying can include comparing the identified equipment and the described service need to previous cases. Using pattern recognition and machine learning, the processing circuits can identify similar situations and the actions taken in those instances.

In various implementations, in response to receiving the prompt identifying the item of equipment for service the processing circuits can access or identify operational data of the one or more sensors attached to the item of equipment. The operational data can be from a plurality of points in time corresponding with the service action. For example, the operational data can correspond to measured parameters including at least one of, but not limited to, temperature measurements, indoor air quality measurements, pressure measurements, vibration measurements, decibel measurements, flow rate measurements, energy consumption measurements, electrical current measurements. The various measured parameters can be used to diagnose the performance and condition of the equipment. In some implementations, accessing may be facilitated by accessing a controller of the item of equipment or the item of equipment itself using network communications (e.g., exchanging data packets). For example, the processing circuits can automatically retrieve historical and real-time data from the sensors through the equipment's control interface. In some implementations, identifying may be facilitated by using network communications to identify and retrieve the relevant data from the item of equipment. For example, the processing circuits can establish a connection to the equipment's controller to gather operational data.

In various implementations, using sensors and sensor fusion can help technicians predict HVAC system failures and maintenance needs through algorithms that leverage the unstructured data. In some implementations, additional sensors can be added to HVAC equipment, creating multiple data streams. By combining data streams from multiple sensors, sensor fusion can facilitate the creation of an accurate representation of an environment or piece of equipment and increase certainty when technicians detect an issue. For example, HVAC sensor data could include system information, including temperature, pressure, vibration, energy, airflow, refrigerant level, and component wear. This data can be analyzed by the processing circuits using a combination of analytics and AI algorithms that identify deviations from normal operating patterns, which can be early indicators of a failure. Technicians can use these data anomalies and prompts with the AI system (e.g., processing circuits) to assess component wear or inefficient operation.

At block 910, a completion representing a service action to perform for the item of equipment, the at least one generative AI model configured using training data including a plurality of unstructured data elements corresponding to items of equipment can be generated, using at least one generative artificial intelligence (AI) model and based on the prompt. In various implementations, the service action is a produced response tailored to address the specific issues of the piece of equipment identified in the prompt. The generative AI model (e.g., first model 104, the second model 116) used for this purpose can be configured using training data from any of a variety of data sources. This data can include a multitude of unstructured data elements that correspond to a diverse range of equipment items.

As used herein, “unstructured data” can include data that lacks a predefined organization or structure within a database and does not adhere to a specific format. This type of data encompasses various information derived from diverse sources, such as textual documents, images, sensor data, logs, or any other data format that the processing circuits are capable of handling. Unlike structured data, which is typically organized into tables and fields, unstructured data is typically not easily searchable or analyzable without employing specialized techniques or tools designed to extract meaning and insights from its heterogeneous and irregular nature. For example, the unstructured data elements are representative of the range of possible equipment items and their associated service histories, operational parameters, and potential problems.

In various implementations, the generative AI model can employ machine learning techniques to transform the raw, unstructured data into valuable insights and service actions. For example, the machine learning techniques can include applying patterns, correlations, and trends discovered in the training data to the prompt at hand. In some implementations, the model can output predictions and generate service actions even for equipment types or service scenarios that it has not encountered before.

In some implementations, the service action generated at block 910 is a product of the AI model's understanding of the prompt, its knowledge acquired from the training data, and its generative capabilities. For example, the action can be a direct instruction to fix a certain part, a suggestion for further diagnostic tests to narrow down the problem, or a recommendation for preventive maintenance to avoid future issues. In some implementations, the generative AI model executed by the processing circuits can also take into account any operational goals of the facility manager as conveyed through the prompt or previous interactions.

In various implementations, the unstructured data elements that correspond to various items of equipment can be collected or received from various information sources. These can include service reports, which can detail the past services performed on equipment; maintenance records, which can log routine maintenance activities; and manufacturer instructions, which can contain data about the recommended operation and care of the equipment. In particular, these sources of data can provide information about the equipment's history, current condition, and optimal operating parameters. Additionally, the processing circuits can also employ or incorporate visual and auditory data into its knowledge base. For example, it can process images of the equipment. Furthermore, the processing circuits can analyze audio recordings of the equipment's operating sounds. For example, unusual noises might indicate a mechanical problem, while changes in the sound level could suggest issues with power supply or efficiency. In some implementations, the processing circuits can employ or incorporate expert technician records into its knowledge base. These records might include unique observations, problem-solving strategies, or preventive maintenance practices. In some implementations, the processing circuits can employ or incorporate media including identification tags or labels of items of equipment into its knowledge base. For example, identification tags can provide unique serial numbers or model numbers that help to track the specific history and service records of each equipment item. In another example, a label with a QR code or barcode can be scanned to retrieve detailed information about the equipment, such as its model number, serial number, manufacturing date, and service history.

In some implementations, the processing circuits can activate a co-pilot model of the generative AI model by initiating a session to assist in servicing the item of equipment based on the plurality of unstructured data elements and the operational data of the item of equipment. Activating can include initiating a session with the co-pilot model through an interface, such as a software application or web-based platform. For example, this could involve the technician logging into a service portal where the co-pilot model is accessible and starting a new session specific to the equipment in question. In some implementations, initiating the co-pilot based on the plurality of unstructured data elements and the operational data of the item of equipment can include pre-loading the session with relevant data from the equipment's history, recent performance metrics, and any recent diagnostic data collected. The co-pilot model of the generative AI model may be trained and deployed to provide real-time assistance and recommendations. For example, the co-pilot can be trained to provide feedback related to items of equipment. In some implementations, the feedback may be from interpreting live data streams from sensors attached to the equipment and providing immediate feedback on potential issues. In this example, the co-pilot model can be customized to interact with the technician by suggesting diagnostic tests, providing step-by-step repair instructions, or simulating potential outcomes based on different maintenance actions. In some implementations, the session can be facilitated through a display or viewport of a client device. For example, the technician could use a tablet or augmented reality headset to view the co-pilot's recommendations overlaid on the physical equipment. In the session, the processing circuits can receive the prompts and provide feedback that guides the technician through the repair or maintenance process. Additionally, initiating a session may be for routine maintenance, emergency repairs, system upgrades, or any other specific service need as dictated by the operational requirements of the facility.

Typical conversational AI systems are often implemented for broad, topic-agnostic interactions and lack domain-specific specialization. In contrast, the co-pilot model and implementations described herein integrate specialized training data from unstructured elements specific to various domains. These elements can include service reports, maintenance records, manufacturer instructions, images of equipment, audio recordings of operating sounds, expert technician records, and media containing identification tags or labels. This diverse and tailored data provides the source for the co-pilot model to generate precise and actionable instructions, recommendations, and strategies. The co-pilot model can interpret real-time data streams, providing immediate feedback based on live operational conditions. In some implementations, the processing circuits executing the co-pilot model can interface with users through various devices, such as augmented reality headsets or service portals, facilitating context-aware assistance. The design of the co-pilot model relates to integrating operational data and specific task-related information, unlike typical conversational AI systems that do not provide domain-specific, actionable insights or real-time feedback based on such training data.

In some implementations, the processing circuits can execute a generative AI model to assist with troubleshooting and maintenance tasks. The generative AI model, also referred to as a co-pilot model or co-pilot, can utilize unstructured data such as service manuals, historical service data, other insights, and real-time operational data. When a technician encounters an issue or performs maintenance, the co-pilot model can provide immediate, context-specific assistance. For example, the technician can input a question or take a picture of the equipment (or provide a real-time video feed), and the co-pilot model can extract relevant information, such as the model number and associated service history, from the provided data (including from the prompt). That is, the co-pilot model can facilitate the interaction with a knowledge base through a natural language interface, improving the troubleshooting and repair process. The processing circuits can further enhance these technical improvements by integrating multimodal data sources, using video and audio inputs to access equipment information and generate accurate service recommendations.

In some implementations, the processing circuits can compare the completion representing the service action to historical service actions associated with similar items of equipment within the unstructured data elements. In general, the comparison process could involve one or more steps. For example, one step could identify past service actions that are similar to the proposed action, cither by matching the type of equipment or the nature of the issue. In another step, the processing circuits could analyze the outcomes of those past actions, assessing factors such as the time taken, resources used, or effectiveness of the solution. Based on this analysis, the processing circuits could execute another step, determining whether the proposed action is likely to be successful, or whether modifications or alternative actions should be considered. After the comparison process, the processing circuits can refine or update the completion based on the comparison (e.g., insights gained). For example, the refinement or update could include tweaking the action's details, suggesting alternative actions, or providing additional context or instructions to help provide successful implementation.

Furthermore, the processing circuits can compare, using a plurality of modalities of data input, the completion representing the service action to a first modality of the plurality of modalities corresponding to historical service actions associated with similar items of equipment in the plurality of unstructured data elements, and a second modality of the plurality of modalities corresponding to operational data from one or more sensors attached to the item of equipment. For example, the first modality may be textual data from maintenance records and service reports. In another example, the second modality may be real-time sensor data capturing operational parameters such as temperature, vibration, and power consumption. In some implementations, the plurality of modality data inputs can be combined and modeled with the competition (e.g., output of the model). That is, the processing circuits can integrate historical service information with current sensor data to perform comparison to attempt to achieve increased accuracy and improved context-specific service actions.

In some implementations, the processing circuits may assign weights to the unstructured data elements present within the training data. These weights act as a representation of the importance, reliability, or relevance of the data elements, influencing the degree to which they are considered during the AI model's learning process and the generation of service actions. In various implementations, the weights can be determined by various factors. One such factor could be the type of data source. For example, data derived from manufacturer instructions might be given a higher weight due to its authoritative nature, while data sourced from an online forum might be assigned a lower weight due to its potential variability in accuracy. Another determining factor could be the granularity of the unstructured data elements (e.g., the level of detail or specificity present in the data). For example, a detailed maintenance record that lists each service action performed on a specific equipment model could be assigned a higher weight compared to a general service report that covers multiple types of equipment.

Additionally, the relatedness of the unstructured data elements to the item of equipment is another factor that can influence the assigned weights. For example, data elements that directly pertain to the specific type or model of equipment being serviced could be assigned a higher weight because of their direct relevance. Conversely, data elements related to different types of equipment might be given lower weights. It should be understood that relatedness refers to the degree to which the unstructured data elements directly pertain to, or have a connection with, the specific type or model of equipment being serviced. This can be determined by the processing circuits by analyzing the data elements and assessing whether they are applicable to the equipment in question, whether they provide insights pertaining to the functionality, performance, or maintenance of that type of equipment, and whether they can help in predicting or diagnosing potential issues with that particular model. For example, an equipment log detailing maintenance procedures for a specific HVAC model would have a high degree of relatedness to that model and thus be assigned a higher weight in the AI's learning process. Conversely, a general troubleshooting guide for a range of HVAC systems would have lower relatedness to that specific model, leading to a lower weight assignment.

Moreover, the experience level of a human source contributing the unstructured data elements could also influence the weight assignments. For example, data contributed by a highly experienced technician might be given a higher weight because of the reliability and depth of insight likely present in such data. In some implementations, the processing circuits can re-evaluate and adjust the assigned weights based on various factors. For example, one factor could be the effectiveness of previous service actions. That is, if a certain data element led to an effective service action in the past, its weight might be increased. On the other hand, if a data element contributed to an ineffective service action, its weight could be decreased. It should be understood that effectiveness refers to the measure of how well a particular service action achieves its intended goal, characterized by the extent to which equipment performance, efficiency, and operational stability are restored or improved following the action. The processing circuits, in determining effectiveness, can take into account the quality of the outcome and the degree to which the service action mitigated or resolved the identified issue. For example, if a service action to replace a faulty compressor in an HVAC unit results in the system returning to its optimal cooling capacity and reduces recurrent maintenance requests, this action would be considered highly effective.

In terms of numerical values, effectiveness can be quantified through measurable metrics. For example, when a service action was undertaken to improve the energy efficiency of an HVAC system that was previously consuming 5000 kWh per month, if the service action involves the implementation of smart thermostats, and this results in reducing the energy consumption to 4000 kWh per month, the effectiveness of this action can be quantified as a 20% reduction in energy usage (e.g., (5000-4000)/5000)×100%). In another example, when a service action was performed to decrease the repair frequency of an HVAC unit that previously required servicing six times a year, if, after the service action, the unit requires servicing only twice a year, the effectiveness of the action can be measured as a 66.67% reduction in repair frequency (e.g., (6-2)/6×100%).

Additionally, changes in the experience level of the human source can also trigger a re-evaluation of weights. For example, if a technician gains additional qualifications or years of experience, the weight of the data they contributed might be increased to reflect their enhanced expertise. Furthermore, updates to the item of equipment can also lead to a re-evaluation of weights. If a piece of equipment is upgraded or modified, the data elements related to its previous version might be given lower weights, while data pertaining to the new version might be given higher weights.

In one example, consider five unstructured data elements utilized for training the generative AI model for an HVAC system: manufacturer's instructions (MI), an online forum discussion (OF), detailed maintenance records (DMR), general service report (GSR), and technician's personal notes (TPN). At the start, each data element might be assigned a weight based on its perceived reliability and relevance: MI receives a weight of 0.35 due to its authoritative nature, OF is assigned a weight of 0.05 due to its variable accuracy, DMR is given a weight of 0.25 for its detailed and specific information, GSR gets a weight of 0.15 as it covers multiple equipment types, and TPN is allocated a weight of 0.20 considering the experience and insight of the technician. Over time, these weights may be adjusted based on the outcomes of the generated service actions. For instance, if the service actions derived primarily from OF prove to be ineffective, the weight of OF might be reduced to 0.03. Conversely, if service actions influenced heavily by DMR lead to efficient repairs, the weight of DMR might be increased to 0.30. If the technician contributing the TPN gains additional qualifications, their contributions' weight might be boosted, from 0.20 to 0.22, to reflect the increased reliability of their data. Finally, if the HVAC system is upgraded, the weights might be adjusted to give more importance to data elements relevant to the new system version. As an example, the weight of MI for the new system could be increased to 0.40, while those for the old version could be decreased.

In various configurations, the generation of the completion representing the service action can account for equipment-specific information, such as the age of the item of equipment and its service history, including previous service actions performed on the equipment. For example, older equipment might be more prone to wear-and-tear issues, may have outdated components, or may not meet current efficiency standards. In some implementations, the service history of the equipment can provide information about the equipment's past issues, how they were addressed, and their outcomes. Additionally, the processing circuits executing the generative AI model can identify patterns within the service history of the equipment. These patterns may relate to recurring issues, successful repair strategies, or regular maintenance needs. For example, if the model identifies a pattern of a particular component failing after a certain period of use, it may suggest proactive replacement of this component in similarly aged equipment.

In some implementations, the processing circuits may identify potential service actions associated with preventive maintenance based on the equipment's age and service history. The generated completion representing the service action can then include these preventive maintenance actions, facilitating the proactive addressing of the equipment's maintenance needs. It should be understood that preventive maintenance actions can refer to proactive measures taken to avoid future breakdowns or malfunctioning of equipment, including routine inspections, cleaning, or parts replacement according to a set schedule, with the goal of keeping the equipment in optimal operating condition. However, potential service actions can be reactive, identified by the generative AI model in response to a detected anomaly or issue, such as unusual equipment noise, overheating, or inefficient performance, and could involve corrective actions like repairs, adjustments, or parts replacement to restore the equipment to its normal function.

In various implementations, the completion representing the service action may also include a suggested timeline for future service actions. In particular, the timeline can take into account the urgency of the future service action, as well as the operational requirements of the equipment. Urgency can refer to the degree of necessity or immediacy for a particular service action to be performed on a piece of equipment to avert potential failure, degradation of performance, or any situation that would negatively impact the operation. For example, if a piece of equipment shows signs of excessive heat generation, urgent action might be required to perform an inspection and possibly replace faulty parts to avoid potential fire hazards or damage to surrounding equipment. The operational requirements of the equipment, such as its role in the facility, its usage patterns, or its criticality, can also influence the timeline determination. For example, equipment that is critical to the facility's operation may have its maintenance or repair actions scheduled during downtime to minimize disruption. In some implementations, the processing circuit can schedule the future service actions. The processing circuits can consider the equipment-specific information, the estimated time to complete the service action, and the availability of a service professional.

Expanding on of scheduling, the processing circuits, in various embodiments, can adjust the timeline for future service actions based on real-time data and predictive analytics. The generative AI model can analyze patterns in the equipment's performance data, recognizing trends and making predictions about future performance, which can then inform the scheduling of service actions. For example, if the data reveals that a particular HVAC system often encounters problems in the warmer months, the AI model might suggest scheduling preventative maintenance in the spring. Conversely, if the system shows consistent high performance and lacks significant issues, the AI model might recommend a longer interval between routine service appointments.

In cases where multiple service actions are needed across different pieces of equipment, the processing circuits can optimize the schedule to improve overall efficiency. It might, for example, recommend bundling several service actions together if they can be performed by the same technician, or if they require similar tools or resources. Furthermore, the AI model can take into account other variables that might influence the scheduling, such as the availability of replacement parts, budget constraints, and external factors like weather conditions or peak usage times. For example, if a specific replacement part is in limited supply, the AI model might suggest expedited service actions for equipment that relies on that part, to prevent potential future downtime.

In some implementations, the AI model can also consider the preferences or schedules of the service professionals themselves. If a certain technician has specialized skills for servicing a particular type of equipment, the processing circuits can prioritize scheduling them for relevant service actions. Similarly, if a technician prefers certain working hours or has availability constraints, the AI model can factor these into the scheduling process.

In some implementations, the generative AI model deployed by the processing circuits can apply natural language processing (NLP) techniques, enabling the generative AI model to parse, interpret, and derive meaning from various forms of human language input. For example, in applying NLP the generative AI model can parse, interpret, and derive meaning in written text from service reports or verbal instructions from a technician. In another example, NLP could be used to decode technical descriptions, parse sentences in manufacturer instructions, or understand nuances in service feedback notes. In various implementations, the processing circuits executing the generative AI model can implement reinforcement learning.

In some implementations, the generative AI model implements reinforcement learning. This can include updating the model based on feedback received regarding the effectiveness of the generated completions indicating the actions. This could include explicit feedback from the users or implicit feedback based on the processing circuits or BMS's observations of user behavior or the outcomes of the implemented actions. For example, if a suggested action leads to significant energy savings, the processing circuits implementing the model might prioritize similar actions in the future. Conversely, if a proposed action does not resolve a reported issue, the processing circuits implementing the model might adjust its approach for similar situations.

In some implementations, generating the completion representing the service action can be based on receiving the prompt and the operational data being provided as input into the at least one generative AI model. That is, the prompt and operational data can be processed together to contextualize the service action. For example, the prompt might describe an issue with the equipment, and the operational data could provide real-time performance metrics to further clarify the problem. In another example, the prompt might request a maintenance check, and the operational data could indicate specific areas where performance is suboptimal, guiding the focus of the maintenance. In some implementations, the co-pilot model that was activated can take the prompt from the user and provide and/or generate operational data in a format to provide as input to the AI model. For example, the co-pilot model can convert a verbal description of an issue into a structured data format that the AI model can process. In another example, the co-pilot model can integrate sensor data readings with the user's input to enhance the accuracy and relevance of the generated service action.

That is, unlike in typical conversational AI systems where the interaction is generally limited to processing and responding to user inputs in natural language, the co-pilot model can supplement the input data with additional data sources such as real-time operational data, historical maintenance records, sensor readings, and manufacturer guidelines. This integration results in the co-pilot model processing and analyzing a broad set of data concurrently, providing accurate and context-specific service action. For example, while a typical conversational AI system may generate a response based on the user's description of an issue, the co-pilot model can incorporate historical service data, real-time sensor data such as temperature or vibration levels, and manufacturer instructions to determine the nature of the problem. This multi-source input can facilitate the generation of improved output and actionable recommendations. Additionally, the co-pilot model can pre-process and format the diverse data sources into structured formats that the AI model can efficiently utilize, improving the relevance and effectiveness of the generated service actions.

At block 915, the completion using at least one of a display device or an audio output device can be presented. In various implementations, the output can be based on a context or preference of the user. For example, if the recipient is a technician working on the equipment, the service action could be displayed as a step-by-step guide on a handheld device, a heads-up display on a smart helmet, or a voice-guided instruction via earphones. If the recipient is a control system, the completion could be transmitted as a set of executable instructions. It should be understood that the choice of presentation mode is not limited to one type but can be customized to the specific user or situation.

In some implementations, the processing circuit can determine the item of equipment includes at least one connectivity element. The determination can be based on the item of equipment having at least one factory-installed communication system or retrofit communication system for facilitating data transmission. For example, the factory-installed communication system may be a built-in Ethernet or Wi-Fi module that allows the equipment to connect to the facility's network. In another example, retrofit communication system may be an add-on device like a Bluetooth or Zigbee module that can be attached to older equipment to facilitate data transmission.

In some implementations, the processing circuits can facilitate a secure connection with the item of equipment based on transmitting a connection request to the at least one connectivity element and receiving a confirmation response. Facilitating the secure connection may include initiating a handshake protocol to establish a secure communication channel. For example, the secure connection may be established using encryption protocols such as TLS/SSL to facilitate data integrity and confidentiality. The connection request can include identification credentials and one or more security token to authenticate the equipment. For example, the connection request may contain a unique identifier and a digital certificate issued by a trusted authority or the processing circuit. The confirmation response may include a session key and acknowledgment of the secure connection. For example, the session key may be a randomly generated cryptographic key used for the duration of the session, and the acknowledgment may be a message confirming the successful establishment of the secure channel.

In some implementations, the processing circuits can monitor the item of equipment in response to presenting the completion using the secure connection. The monitoring may include accessing or receiving diagnosis information. For example, the processing circuits can retrieve error logs and performance reports to evaluate the equipment's condition. The monitoring can include accessing or receiving real-time state data of the item of equipment. For example, the processing circuits can continuously track parameters like temperature, pressure, and operational status. The monitoring may include accessing or receiving the operational data. For example, the processing circuits can analyze historical usage patterns and current operational metrics to predict potential failures and schedule maintenance actions accordingly.

In some implementations, the processing circuits can communicate with equipment shipped from the factory with secure connectivity systems pre-installed. These systems can include factory-installed communication modules designed for data transmission and AI applications. Often referred to as “arriving alive,” these systems can provide continuous data availability for analysis and AI processing while ensuring that the equipment and data remain secure from unauthorized access. The processing circuits, executing the AI model, can use this secure connectivity to receive notifications and conduct remote diagnostics on the equipment. As shown, the data can support proactive maintenance strategies, reducing equipment downtime and emergency service calls. For example, if a notification indicates a worn component requiring service, the processing circuits can facilitate obtaining the necessary replacement part and scheduling the maintenance. The implementations can help reduce equipment failures, unplanned downtime, and service trips.

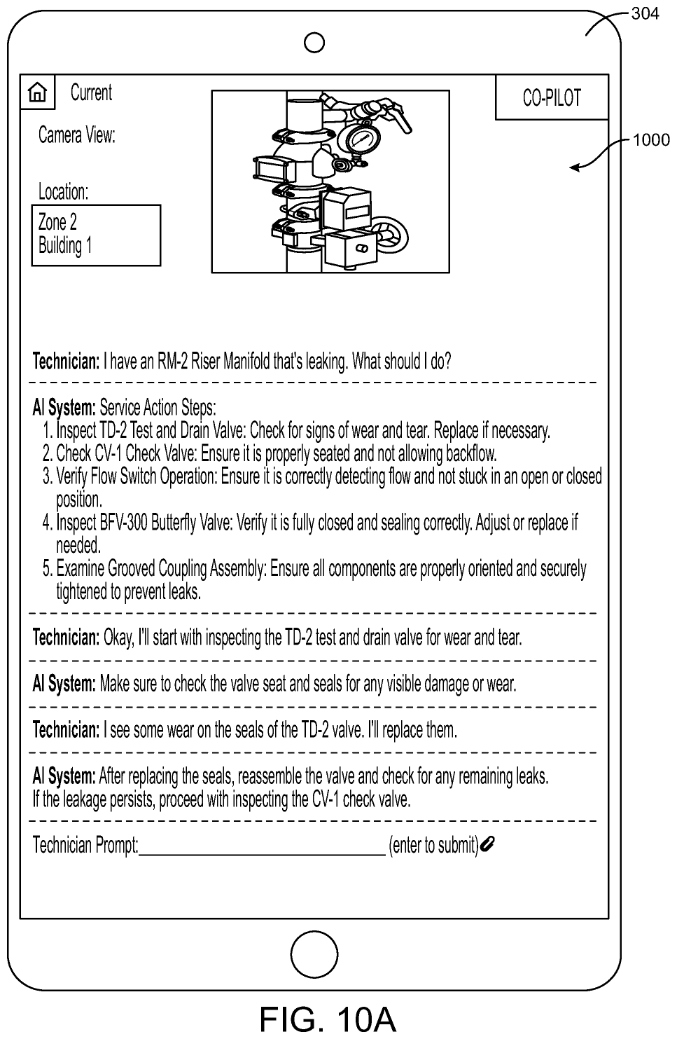

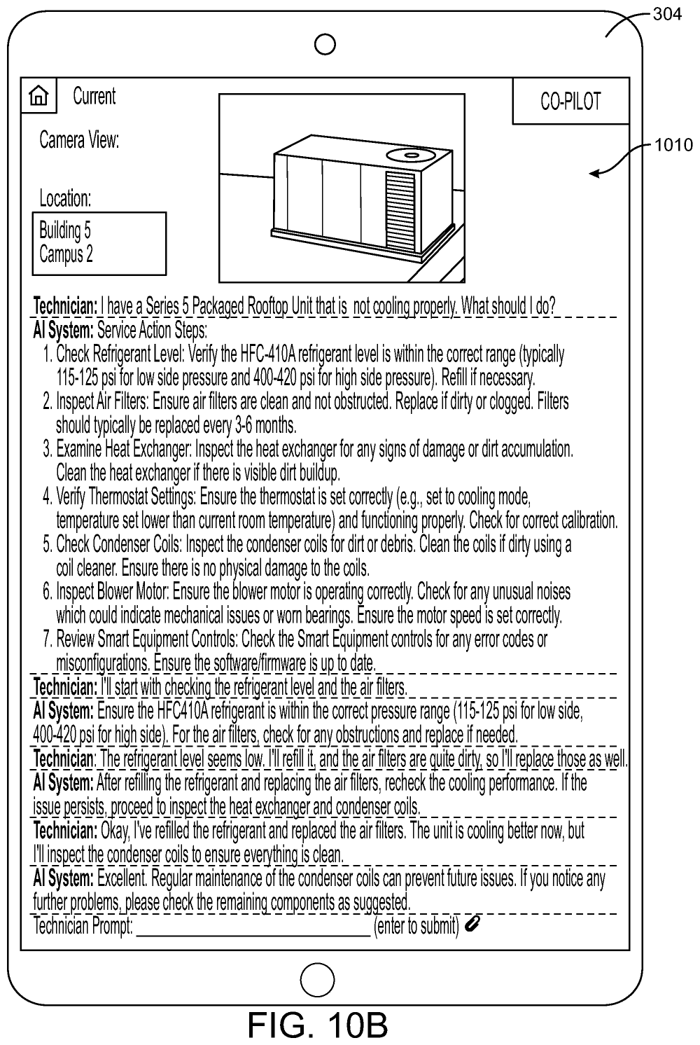

Referring to blocks 905-915 with reference to FIG. 10A, an example graphical interface 1000 facilitating and generating example communications with a technician, according to some implementations. As shown, graphical interface 1000 relates to the interaction between the technician and an AI system for troubleshooting a leaking RM-2 Riser Manifold. In this example, the technician prompts (e.g., block 905), “I have an RM-2 Riser Manifold that's leaking. What should I do?” and the processing circuits respond (e.g., blocks 910-915) with a series of service action steps: “Inspect the TD-2 Test and Drain Valve for signs of wear and tear and replace if necessary. Check the CV-1 Check Valve to ensure it is properly seated and not allowing backflow. Verify the Flow Switch Operation to ensure it is correctly detecting flow and not stuck in an open or closed position. Inspect the BFV-300 Butterfly Valve to verify it is fully closed and scaling correctly; adjust or replace if needed. Examine the Grooved Coupling Assembly to ensure all components are properly oriented and securely tightened to prevent leaks.” The technician prompts, “Okay, I'll start with inspecting the TD-2 test and drain valve for wear and tear.” The processing circuits respond, “Make sure to check the valve seat and seals for any visible damage or wear.” The technician prompts, “I see some wear on the seals of the TD-2 valve. I'll replace them.” The processing circuits respond, “After replacing the seals, reassemble the valve and check for any remaining leaks. If the leakage persists, proceed with inspecting the CV-1 check valve.” On the screen, there can be interactive elements such as a prompt field for allowing the technician to input additional information or attach relevant files to be modeled.

Referring to blocks 905-915 with reference to FIG. 10B, an example graphical interface 1110 facilitating and generating example communications with a technician, according to some implementations. As shown, graphical interface 1010 relates to the troubleshooting process for a Series 5 Packaged Rooftop Unit that is not cooling properly. In this example, the technician prompts (e.g., block 905), “I have a Series 5 Packaged Rooftop Unit that is not cooling properly. What should I do?” and the processing circuits respond (e.g., blocks 910-915) with a series of service action steps: “Check the refrigerant level to verify the HFC-410A refrigerant is within the correct range, typically 115-125 psi for low side pressure and 400-420 psi for high side pressure, and refill if necessary. Inspect the air filters to ensure they are clean and not obstructed, and replace if dirty or clogged, typically every 3-6 months. Examine the heat exchanger for any signs of damage or dirt accumulation, and clean if there is visible dirt buildup. Verify the thermostat settings to ensure it is set correctly (e.g., cooling mode, temperature set lower than current room temperature) and functioning properly, including correct calibration. Check the condenser coils for dirt or debris and clean using a coil cleaner if necessary, ensuring there is no physical damage. Inspect the blower motor to ensure it is operating correctly and check for any unusual noises indicating mechanical issues or worn bearings, and verify the motor speed is set correctly. Review the Smart Equipment controls for any error codes or misconfigurations, and ensure the software/firmware is up to date.” The technician prompts, “I'll start with checking the refrigerant level and the air filters.” The processing circuits respond, “Ensure the HFC-410A refrigerant is within the correct pressure range (115-125 psi for low side, 400-420 psi for high side). For the air filters, check for any obstructions and replace if needed.” The technician prompts, “The refrigerant level seems low. I'll refill it, and the air filters are quite dirty, so I'll replace those as well.” The processing circuits respond, “After refilling the refrigerant and replacing the air filters, recheck the cooling performance. If the issue persists, proceed to inspect the heat exchanger and condenser coils.” The technician prompts, “Okay, I've refilled the refrigerant and replaced the air filters. The unit is cooling better now, but I'll inspect the condenser coils to ensure everything is clean.” The processing circuits respond, “Excellent. Regular maintenance of the condenser coils can prevent future issues. If you notice any further problems, please check the remaining components as suggested.” On the screen, there can be interactive elements such as a prompt field for allowing the technician to input additional information or attach relevant files to be modeled.

Additionally, the graphical interfaces 1000 and 1010 can be presented in a viewport or display of client device 304. The viewport or display can include a touchscreen. In some implementations, graphical interfaces 1000 and 1010 can also include a live view of the camera of the client device 304. For example, the processing circuits can receive a data feed of a real-time view of the item of equipment. The data feed can be used by the processing circuits, in combination with the unstructured data and the operational data to provide context-aware guidance to the technician. That is, the real-time video feed can be analyzed to give specific instructions based on the visual information. As shown, in graphical interface 1000 the data feed can provide real-time video of a technician attempting to service an RM-2 Riser Manifold. In some implementations, the processing circuits could overlay content on the camera view related to the service actions. For example, the processing circuits could highlight the specific components that need to be inspected or replaced by displaying colored outlines or markers directly on the live video feed. In another example, the processing circuits could provide visual indicators for proper assembly alignment by overlaying guides or alignment markers on the components in the live feed. As shown, in graphical interface 1010 the data feed can provide real-time video of a technician attempting to service a Series 5 Packaged Rooftop Unit. In some implementations, the processing circuits could overlay content on the camera view related to the service actions. For example, the processing circuits could indicate the correct pressure levels for refrigerant by displaying the acceptable pressure range in a floating text box next to the pressure gauge shown on the live video feed. In another example, the processing circuits could show the proper cleaning techniques for condenser coils by overlaying step-by-step instructions or animations on the live feed of the condenser coils. As shown, the processing circuits can provide real-time feedback, display diagnostic data, or suggest further actions based on the live feed. Additionally, the graphical interfaces 1000 and 1010 can include location information and if co-pilot has been activated. For example, the graphical interface can display the technician's current location (e.g., in the building) and track their progress through the service steps.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

In various implementations, the steps and operations described herein may be performed on one processor or in a combination of two or more processors. For example, in some implementations, the various operations could be performed in a central server or set of central servers configured to receive data from one or more devices (e.g., edge computing devices/controllers) and perform the operations. In some implementations, the operations may be performed by one or more local controllers or computing devices (e.g., edge devices), such as controllers dedicated to and/or located within a particular building or portion of a building. In some implementations, the operations may be performed by a combination of one or more central or offsite computing devices/servers and one or more local controllers/computing devices. All such implementations are contemplated within the scope of the present disclosure. Further, unless otherwise indicated, when the present disclosure refers to one or more computer-readable storage media and/or one or more controllers, such computer-readable storage media and/or one or more controllers may be implemented as one or more central servers, one or more local controllers or computing devices (e.g., edge devices), any combination thereof, or any other combination of storage media and/or controllers regardless of the location of such devices.

What is claimed is:

1. A method, comprising:
receiving, by one or more processors, a prompt identifying an item of equipment for service;
generating, by the one or more processors using at least one generative artificial intelligence (AI) model and based on the prompt, a completion representing a service action to perform for the item of equipment, the at least one generative AI model configured using training data comprising a plurality of unstructured data elements corresponding to items of equipment; and
presenting, by the one or more processors, the completion using at least one of a display device or an audio output device.

2. The method of claim 1, wherein the plurality of unstructured data elements corresponding to the items of equipment comprise at least one of service reports, maintenance records, manufacturer instructions, images of the item of equipment, audio recordings of equipment operating sounds, expert technician records, or media comprising identification tags or labels of the items of equipment.

3. The method of claim 1, further comprising:
comparing, by the one or more processors using a plurality of modalities of data input, the completion representing the service action to: a first modality of the plurality of modalities corresponding to historical service actions associated with similar items of equipment in the plurality of unstructured data elements, and a second modality of the plurality of modalities corresponding to operational data from one or more sensors attached to the item of equipment; and
refining or updating, by the one or more processors, the completion based on the comparison.

4. The method of claim 3, in response to receiving the prompt identifying the item of equipment for service:
accessing or identifying, by the one or more processors, the operational data of the one or more sensors attached to the item of equipment;
activating, by the one or more processors, co-pilot model of the at least one generative AI model by initiating a session to assist in servicing the item of equipment based on the plurality of unstructured data elements and the operational data of the item of equipment; and
wherein generating the completion representing the service action is based on receiving the prompt and the operational data being provided as input into the at least one generative AI model.

5. The method of claim 3, further comprising:
identifying, by the one or more processors, the operational data at a plurality of points in time correspond with the service action, wherein the operational data correspond to measured parameters comprising at least one of temperature measurements, indoor air quality measurements, pressure measurements, vibration measurements, decibel measurements, flow rate measurements, energy consumption measurements, electrical current measurements.

6. The method of claim 3, further comprising:
determining, by the one or more processors, the item of equipment comprises at least one connectivity element based on comprising at least one factory-installed communication system or retrofit communication system for facilitating data transmission;
facilitating, by the one or more processors, a secure connection with the item of equipment based on transmitting a connection request to the at least one connectivity element and receiving a confirmation response comprising a session key and acknowledgement of the secure connection; and
monitoring, by the one or more processors using the secure connection, the item of equipment in response to presenting the completion by accessing or receiving diagnosis information, real-time state data of the item of equipment, or the operational data.

7. The method of claim 1, further comprising:
assigning, by the one or more processors, weights to the plurality of unstructured data elements in the training data, wherein the weights are determined based on one or more of a type of a data source, a granularity of the plurality of unstructured data elements, a relatedness of the plurality of unstructured data elements to the item of equipment, or an experience level of a human source contributing the plurality of unstructured data elements.

8. The method of claim 7, further comprising:
re-evaluating and adjusting, by the one or more processors, the assigned weights to the plurality of unstructured data elements based on responses received from an effectiveness of previous service actions, changes in the experience level of the human source, or updates to the item of equipment.

9. The method of claim 1, wherein:
the generation of the completion representing the service action is further based on equipment-specific information comprising an age of the item of equipment and a service history comprising previous service actions performed on the item of equipment; and
the at least one generative AI model identifies one or more patterns in the service history of the item of equipment, correlates the one or more patterns with the age and the service history of the item of equipment, to generate the completion representing the service action.

10. The method of claim 9, further comprising:
identifying, by the one or more processors, a potential service action associated with a preventive maintenance action based on the age and the service history of the item of equipment, wherein the completion representing the service action further comprises the preventive maintenance action, wherein the completion representing the service action comprises a suggested timeline for future service actions based on an urgency of the future service action and an operational requirement of the item of equipment; and
scheduling, by the one or more processors, the future service actions based on the equipment-specific information, an estimated completion, and an availability of a service professional.

11. The method of claim 1, wherein:
the at least one generative AI model utilizes natural language processing (NLP) to interpret the plurality of unstructured data elements; and
the at least one generative AI model implements reinforcement learning, wherein the reinforcement learning comprises updating the at least one generative AI model based on receiving feedback on an effectiveness of generated completions representing service actions.

12. A method, comprising:
receiving, by one or more processors, a prompt identifying an item of equipment for service;
generating, by the one or more processors using at least one machine learning model and based on the prompt, a completion representing a service action to perform for the item of equipment, the at least one machine learning model configured using training data comprising a plurality of unstructured data elements corresponding to items of equipment; and
presenting, by the one or more processors, the completion using at least one of a display device or an audio output device.

13. The method of claim 12, further comprising:
comparing, by the one or more processors using a plurality of modalities of data input, the completion representing the service action to: a first modality of the plurality of modalities corresponding to historical service actions associated with similar items of equipment in the plurality of unstructured data elements, and a second modality of the plurality of modalities corresponding to operational data from one or more sensors attached to the item of equipment; and
refining or updating, by the one or more processors, the completion based on the comparison.

14. The method of claim 13, in response to receiving the prompt identifying the item of equipment for service:
accessing or identifying, by the one or more processors, the operational data of the one or more sensors attached to the item of equipment;
activating, by the one or more processors, co-pilot model of the at least one machine learning model by initiating a session to assist in servicing the item of equipment based on the plurality of unstructured data elements and the operational data of the item of equipment; and
wherein generating the completion representing the service action is based on receiving the prompt and the operational data being provided as input into the at least one generative AI model.

15. The method of claim 12, wherein:
the at least one machine learning model utilizes natural language processing (NLP) to interpret the plurality of unstructured data elements; and
the at least one machine learning model implements reinforcement learning, wherein the reinforcement learning comprises updating the at least one machine learning model based on receiving feedback on an effectiveness of generated completions representing service actions.

16. A system, comprising:
processing circuits comprising memory and at least one processor configured to:
receive a prompt identifying an item of equipment for service;
generate, using at least one generative artificial intelligence (AI) model and based on the prompt, a completion representing a service action to perform for the item of equipment, the at least one generative AI model configured using training data comprising a plurality of unstructured data elements corresponding to items of equipment; and
present the completion using at least one of a display device or an audio output device.

17. The system of claim 16, wherein the plurality of unstructured data elements corresponding to the items of equipment comprise at least one of service reports, maintenance records, manufacturer instructions, images of the item of equipment, audio recordings of equipment operating sounds, expert technician records, or media comprising identification tags or labels of the items of equipment.

18. The system of claim 16, the at least one processor is further configured to:
compare, using a plurality of modalities of data input, the completion representing the service action to: a first modality of the plurality of modalities corresponding to historical service actions associated with similar items of equipment in the plurality of unstructured data elements, and a second modality of the plurality of modalities corresponding to operational data from one or more sensors attached to the item of equipment; and
refine or update the completion based on the comparison.

19. The system of claim 18, in response to receiving the prompt identifying the item of equipment for service, the at least one processor is further configured to:
accessing or identifying, by the one or more processors, the operational data of the one or more sensors attached to the item of equipment;
activate co-pilot model of the at least one generative AI model by initiating a session to assist in servicing the item of equipment based on the plurality of unstructured data elements and the operational data of the item of equipment; and
wherein generating the completion representing the service action is based on receiving the prompt and the operational data being provided as input into the at least one generative AI model.

20. The system of claim 18, the at least one processor is further configured to:
determine the item of equipment comprises at least one connectivity element based on comprising at least one factory-installed communication system or retrofit communication system for facilitating data transmission;
facilitate a secure connection with the item of equipment based on transmitting a connection request to the at least one connectivity element and receiving a confirmation response comprising a session key and acknowledgement of the secure connection; and
monitor, using the secure connection, the item of equipment in response to presenting the completion by accessing or receiving diagnosis information, real-time state data of the item of equipment, or the operational data.
